(19) United States
(12) Patent Application Publication
(10) Pub. No.: US 2006/0294235 A1
(43) Pub. Date: Dec. 28, 2006

(54) Management and data handling system and method

(75) Inventor: Janesh Joseph, Las Vegas, NV (US)

Correspondence Address: Bryan Cave, LLP, Suite 2200, 2 North Central Avenue, Phoenix, AZ, 85004, US

(73) Assignee: Creative Management Services, LLC dba MC2

(21) Appl. No.: 11/436,253

(22) Filed: May 17, 2006

Related U.S. Application Data
(60) Provisional application No. 60/681,784, filed on May 17, 2005.

(51) Int. Cl. G06F 15/173

(52) U.S. Cl. 709/225

(57) ABSTRACT

Computer implemented systems for transferring data while maintaining an acceptable level of data security, methods for transferring data between servers, online management systems comprising a plurality of software modules, and methods of managing construction projects, such as construction of trade show exhibits, as well as software used in such systems. An accounting application such a SOLOMON on an intranet server may initiate communication at particular times with an online management system on an Internet server through an intermediate server, and the accounting application may process information from the management system and return results, a job number, or both. Communication initiated by the Internet server may be prevented, and an estimating module may be the hub of the management system. Data may be shared reducing the need to reenter the same information. Material and customer libraries may be used.

### CLAIM OF PRIORITY

This patent application claims priority to U.S. provisional patent application 60/681,784 which was filed on May 17, 2005, and is incorporated by reference herein in its entirety. Further, an international patent application is being filed on the same day as this application under the Patent Cooperation Treaty (PCT) at the United States Patent and Trademark Office that also claims priority to the above United States provisional patent application. That corresponding PCT application has the same title and inventor as this application, and is also incorporated by reference herein in its entirety.

### FIELD OF INVENTION

This invention relates to systems and methods for managing activities, for handling or transferring data, or both. Specific embodiments of this invention relate to systems and methods for managing business activities, systems and methods for managing projects, systems and methods for managing construction or fabrication, software used in such systems and methods, and network or Internet based systems and methods of such types.

### BACKGROUND OF THE INVENTION

Systems and methods have been developed to manage various activities including activities involving fabricating or building things, and such systems and methods have been used and improved throughout human history. In recent decades, computers and software have been used in various management activities and, more recently, networks, including local area networks (LANs), wide area networks (WANs) (collectively intranets), and the Internet, have been used in management activities, including for communication and to access and transfer information. Further, various steps have been taken to secure data transferred in an open network such as the Internet, including encryption and protection of certain web pages with passwords and the like.

In addition, in the modern economy, new products and services are continuously being developed and introduced into the marketplace. When a new product or service is developed, it is important to the success of that product and to the success of those who are introducing it into the marketplace that information about that new product or service be communicated to the public, including to likely consumers, potential distributors, and the like. Many products and services only have applicability to a limited segment of consumers, so it is important for these products and services that they be introduced to a focused group of people who are potential consumers, distributors, etc., of that particular product or service. Further, it is important to consumers and users of particular products and services that they be informed of new products and services that are coming onto the market that they may benefit from. One method that has evolved in the market place to introduce new products or services to a focused group of individuals is to display the new products or services at one or more trade shows.

Many trade shows take place in any given year, and an industry has developed that provides services to entrepreneurs who wish to display new products or services at trade shows. Such services include designing and constructing trade show exhibits, and businesses in this industry conduct functions that include sales, design, estimating, procurement of materials, fabrication, transportation, and erection. All of these activities need to be managed and effective and efficient management is important to the success of such a business. In the past, such management has been performed through conventional means. Computers and networks, including local and wide area networks and the Internet, have been used in the management of businesses that construct trade show exhibits. Further, management applications and accounting applications, including MICROSOFT SOLOMON, have been used in business management, including management of businesses that offer the service of constructing trade show exhibits.

However, needs and the potential for benefit exist in the area of such management, and these needs and potential for benefit often extend to many types of businesses. For instance, needs exist to be able to use the Internet for communication and transferring of data, but needs also exist that an acceptable level of data security be maintained with such systems and methods. Further needs and areas for potential for improvement include improving the availability of information to a number of different functions, reducing duplication in the entering of information, organizing information and providing information in a more-usable form, more effectively transferring information between different applications, including for example, an accounting application and a project management application, providing improved tracking of performance of employees and departments, and the like. Needs and potential for improvement also exist in the area of providing structure and guidance to people involved in various activities, including prompting to obtain information, guidance to follow approved procedures, and the like. Potential for improvement exists in these and other areas that may be apparent to a person of skill in the art having studied this document.

### SUMMARY OF PARTICULAR EMBODIMENTS OF THE INVENTION

This invention provides, among other things, a number of computer implemented systems for transferring data while maintaining an acceptable level of data security, various methods for transferring data between an Internet server and an intranet server, certain computer-implemented management systems comprising a plurality of software modules organized in particular configurations, and particular methods of managing construction projects, as examples. Various embodiments of the invention provide as an object or benefit that they partially or fully address one or more of the needs, potential areas for improvement, and functions described herein, for instance. The present invention provides various embodiments that may provide a higher level of data security, be easier to use, accomplish more functions, provide more useful information, provide a better level of control, or a combination thereof, in comparison with various prior art. Further features and advantages of the invention may be apparent to those skilled in the art.

As mentioned, a number of embodiments of the invention provide a computer-implemented system for transferring data while maintaining an acceptable level of data security. In such examples, the system includes an Internet server running at least a first software application, an intranet server running at least a second software application, and an intermediate server. The intranet server in this example is configured to automatically initiate communication with the Internet server through the intermediate server, and the system is configured to prevent communication between the Internet server and the intranet server that is initiated by the Internet server.

In some such embodiments, the second software application is an accounting module, and in some particular embodiments, the second software application is MICROSOFT SOLOMON, for instance. Further, in some embodiments, the first software application is a management application, which, in some embodiments, is configured to manage a plurality of construction projects, such as the construction of a plurality of tradeshow exhibits, for example. The communication, in certain embodiments, includes transfer of information from the first software application to the second software application, processing of the information by the second software application into results, and transfer of the results from the second software application back to the first software application. Further, in some embodiments, the communication includes transfer of a next sequential job number from the second software application to the first software application.

In various embodiments, the intranet server is configured to automatically initiate communication with the Internet server at particular times, which may be at periodic intervals of time, for example. For instance, in some embodiments, the intranet server is running on MICROSOFT WINDOWS having a Scheduled Task option, and the Scheduled Task option is used to automatically initiate communication with the Internet server. In a number of embodiments, the system further includes one or more of a number of software modules. Such software modules may include, for example, a project preliminary module, a new client request module, a vendor editor module, a requisition/purchasing module, a time tracker module, a project performance module, or a combination thereof.

In other examples, the invention also provides various methods for transferring data between an Internet server and an intranet server while maintaining an acceptable level of data security. An example of such a method includes (in any order) at least the steps of (1) using the intranet server to initiate communication between the intranet server and the Internet server through an intermediate server, and (2) not allowing communication between the Internet server and the intranet server that is initiated by the Internet server. In some embodiments, the method further includes the steps of transferring information from the Internet server to the intranet server through the intermediate server, processing the information into results at the intranet server, and transferring the results from the intranet server to the Internet server. In addition, in some embodiments, the processing includes performing computations using an accounting application, for example, performing computations using MICROSOFT SOLOMON.

Such methods may further include the step of managing a business activity using a management application loaded on the Internet server. In some embodiments, the managing of the business includes managing a plurality of construction projects, for example, which may include managing the construction of a plurality of trade show exhibits. Moreover, certain embodiments further include the step of transferring a next sequential job number from the intranet server to the Internet server. Further, in a number of embodiments, the step of using the intranet server to initiate communication includes automatically initiating communication at particular times, for example, at periodic intervals of time. For instance, in certain embodiments MICROSOFT WINDOWS, having a Scheduled Task option, is loaded on the intranet server and the method further includes the step of using the Scheduled Task option to automatically initiate communication with the Internet server.

The invention also provides, in a number of embodiments, a computer-implemented management system that includes a plurality of software modules including an estimating module configured to be used to estimate the time and cost of projects, and a plurality of other modules configured to perform specific functions. In this embodiment, the other modules are each configured to interface predominantly with the estimating module such that the estimating module serves as a hub for the other modules within the management system. In some of these embodiments, data entered initially into the estimating module is used to populate fields in at least a plurality (or all) of the other modules.

In various embodiments, the management system further includes an accounting application configured to perform accounting functions. In some embodiments, the system includes a first server onto which the estimating module is loaded and a second server onto which the accounting application is loaded. And further, in some such embodiments, an intermediate server is included that is configured and arranged to facilitate transfer of information between the first server and the second server. In some embodiments, for example, the first server is an Internet server and the second server is an intranet server.

In a number of these embodiments, the other software modules include a time tracker module configured to track actual time and actual cost of the projects, a project performance report module configured to prepare reports that compare estimated cost and time of projects with actual time and cost of the projects, a project preliminary module configured to facilitate input of information about potential new projects and at least the estimating module uses at least some of the information input into the project preliminary module, an agreement module configured to prepare an agreement for signature for at least one of a new customer and a new project, a requisitioning/purchasing module configured to prepare at least one of requisitions and purchase orders for obtaining at least one of materials and services, or a combination thereof, for example.

Furthermore, the invention also provides, in yet another example, a method of managing a plurality of construction projects. This particular method includes (in any order) the steps of (1) using a computer-implemented accounting application loaded on an intranet server to perform accounting functions associated with the construction projects, (2) using a network-based computer-implemented management application loaded on an Internet server and configured to be accessed by a plurality of users and to exchange information with the accounting application so that at least some of the information will not have to be entered twice for the management application and the accounting application, and (3) allowing at least some personnel to enter information about new projects into the management application. This embodiment further includes the steps of (4) using the management application to provide guidance to the personnel to require that certain of the information be entered before proceeding to at least one subsequent step, and (5) using at least the management application, the accounting application, and the information about the new projects to estimate the cost to complete the projects and (using the estimate) produce proposals for the projects. This method further includes the step of (6) using at least the management application, the accounting application, and the information about the new projects, preparing reports showing progress of the projects.

In some embodiments, the construction projects include construction of trade show exhibits, for instance. Further, in some embodiments, communication between the management application and the accounting application occurs only when initiated by the accounting application. And some embodiments further include the step of using an intermediate server to facilitate communication between the management application and the accounting application.

### BRIEF DESCRIPTION OF THE DRAWINGS

FIG. 1 is a block diagram illustrating a computer-implemented system for transferring data over a network in accordance with the invention while maintaining an acceptable level of data security;

FIG. 2 is a block diagram illustrating a computer-implemented or online system in accordance with the invention that includes an estimating module that serves as a hub for other modules within the system;

FIG. 3 is a flowchart illustrating a method for transferring data between a first server and a second server in a network environment in accordance with the invention while maintaining an acceptable level of data security;

FIG. 4 is a flowchart illustrating a method for managing a plurality of projects in accordance with the invention;

FIG. 5 is a screen shot illustrating a main menu of a computer-implemented or online system which is provided to illustrate an example of the invention;

FIG. 6 is a screen shot illustrating a page titled “Add New Client Creation Request” of a computer-implemented or online system which is provided to illustrate an example of the invention;

FIGS. 7A and 7B illustrate top and bottom portions of a screen shot of a page titled “Design/Estimating Pre Design Worksheet” of a computer-implemented or online system which is provided to illustrate an example of the invention;

FIG. 8 is a screen shot illustrating a page titled “Project Time Tracker” of a computer-implemented or online system which is provided to illustrate an example of the invention;

FIG. 9 is a screen shot illustrating a page titled “Select a Material” of a computer-implemented or online system which is provided to help to illustrate an example of the invention;

FIG. 10 is a screen shot illustrating a page called “Project Time Material Entry Report” of a computer-implemented or online system which is provided to illustrate an example of the invention;

FIG. 11 is a screen shot illustrating a page titled “Materials/Service Requisitioning” of a computer-implemented or online system which is provided to further illustrate an example of the invention;

FIG. 12 is a screen shot illustrating a page titled “Purchase Requisition Request” of a computer-implemented or online system which is provided to illustrate an example of the invention;

FIG. 13 is a screen shot illustrating a page also titled “Purchase Requisition Request” of a computer-implemented or online system which is provided to contribute to an illustration of an example of the invention;

FIG. 14 is a screen shot illustrating a page titled “Solomon Data Input” of a computer-implemented or network-based system which is provided to illustrate an example of the invention;

FIG. 15 is a screen shot illustrating a page titled “Classification” that lists classifications of materials in a materials library of a computer-implemented or online system which is provided to illustrate an example of the invention;

FIG. 16 is a screen shot illustrating a page titled “Divisional Vender List” of a computer-implemented or online system which is provided to illustrate an example of the invention;

FIG. 17 is a screen shot illustrating a page titled “Invoice” of a computer-implemented or online system which is provided to illustrate an example of the invention;

FIG. 18 is a screen shot illustrating a page titled “Final Invoice Collation” of a computer-implemented or online system which is provided to illustrate an example of the invention;

FIG. 19 is a screen shot illustrating a page titled “Final Invoice” of a computer-implemented or online system which is provided to illustrate an example of the invention;

FIGS. 20A and 20B illustrate top and bottom portions of a screen shot of a page titled “Summary and Detail” of a computer-implemented or online system which is provided to help illustrate an example of the invention;

FIG. 21 is a screen shot illustrating an example of a page called “Select Client” concerning data from an accounting application which is provided to illustrate an example of the invention;

FIG. 22 is a screen shot illustrating a page titled “Project Preliminary” of a computer-implemented or online system which is provided to further illustrate an example of the invention;

FIG. 23 is a screen shot illustrating a page titled “Project Maintenance” of an accounting application which is provided to illustrate an example of the invention;

FIG. 24 is a screen shot illustrating a page titled “Additional Project Information” provided to illustrate an example of the invention;

FIG. 25 is a screen shot illustrating a page titled “Billing Information Maintenance” of an accounting application which is provided to illustrate an example of the invention;

FIG. 26 is a screen shot illustrating a page titled “Add New Client Creation Request” provided to further illustrate an example of the invention;

FIG. 27 is a screen shot illustrating a page titled “Materials/Service Requisitioning” provided to further illustrate an example of the invention; and

FIG. 28 is a screen shot illustrating a page titled “Purchase Requisition Request” also provided to further illustrate an example of the invention.

### DETAILED DESCRIPTION OF EXAMPLES OF EMBODIMENTS

Various embodiments of the invention include systems and methods for managing various activities and systems and methods of transferring data, for example, while maintaining an acceptable level of data security. In certain embodiments businesses are managed, computers and computer software are used, at least one network is used, such as an intranet, the Internet, or both, or a combination thereof. Specific embodiments relate to the management of businesses engaged in construction generally, construction of custom environments, or in certain embodiments, the construction of trade show exhibits or kiosks specifically. In addition, many embodiments of the invention provide structure for the people that use the invention. This structure provides guidance to the people who use such embodiments, including helping them to follow approved procedures, prompting them to obtain and enter required information, reminding them of steps that should be taken, and the like. Such structure includes, in some embodiments, preventing certain individuals from accessing certain data, preventing certain individuals from changing certain data that they may have access to, preventing certain individuals from taking certain steps unless other steps are taken, particular information is entered, approval is granted, contracts are signed, payment is obtained, or the like. Accordingly, the following is a description of various examples of the invention which includes the inventor's best mode of practicing the invention.

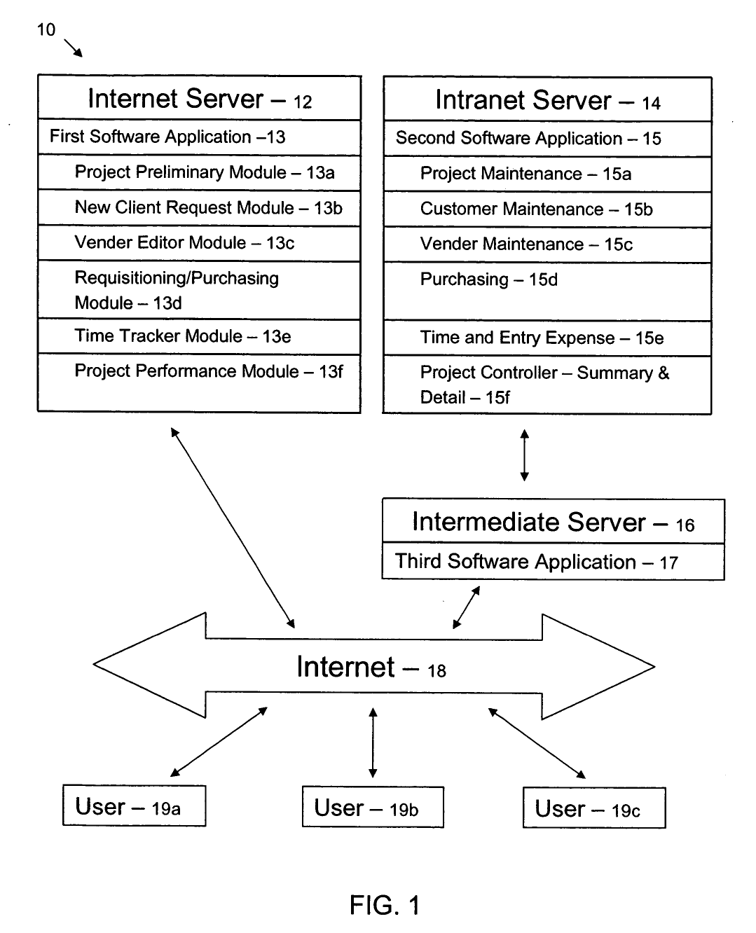

FIG. 1 illustrates one of a number of embodiments of the invention that provide a computer-implemented system 10 for transferring data while maintaining an acceptable level of data security. In this example, system 10 includes an Internet server 12 running at least a first software application 13, an intranet server 14 running at least a second software application 15, and an intermediate server 16. In the embodiment illustrated, a third software application 17 is running on intermediate server 16.

In a number of embodiments, intranet server 14 is configured to automatically initiate communication with Internet server 12 through intermediate server 16 and Internet 18, and system 10 is configured to prevent or not allow communication between Internet server 12 and intranet server 14 that is initiated by Internet server 12. In some embodiments, system 10 is configured to prevent or not allow communication between Internet 18 and intranet server 14 that is initiated by or through Internet 18. In certain embodiments, system 10 is configured to prevent or not allow communication between any publically accessible network and intranet server 14 that is initiated by any source other than intranet server 14. In some embodiments, intranet server 14, second software application 15, intermediate server 16, third software application 17, or a combination thereof, for example, may prevent or not allow communication between Internet server 12, for example, and intranet server 14 that is initiated by Internet server 12, through internet 18, or both, for instance.

In various embodiments, intermediate server 16 is used as an interpreter between first software application 13 and second software application 15. In some embodiments, including intermediate server 16 may at least partially avoid problems that may result from intranet server 14 having direct access to an unsecured network such as Internet 18, for example. In a number of embodiments, intermediate server 16 may at least partially protect intranet server 14, second software application 15, or both, from viruses, worms, or other suspicious codes, for example, which otherwise might be received from Internet 18, for instance.

In some embodiments, intermediate server 16 may also serve as a depository server to store some or all integrated data (e.g., from fist software application 13 and second software application 15), for instance, for future reference. In many embodiments, intranet server 14 is not directly accessible to Internet server 12 or to Internet 18 generally, or to other unsecured or publically accessible networks for the most part, except through intermediate server 16. Thus, in various embodiments, other servers, for example, on Internet 18, cannot connect to or transfer information to intranet server 14 or second software application 15, for example. Even so, Intranet server 14 may be a server on a local area network (LAN), such as a company network or intranet, which may be private and not accessible by the public. In various embodiments, second software application 15 may be accessible, for example, to authorized users, through the intranet to which intranet server 15 is a part or acts as the server. In some embodiments, second software application 15 may be accessible through a Citrix server, as another example.

In some embodiments, any communication with intranet server 14 or second software application 15 that is initiated from an external source through Internet 18 is prevented or not allowed. In some embodiments, any communication with intermediate server 16 or third software application 17 that is initiated through Internet 18 is prevented or not allowed. In some embodiments, communication through Internet 18 with intranet server 14, second software application 15, intermediate server 16, third software application 17, or a combination thereof may take place and be allowed where initiated by intranet server 14 or second software application 15.

In the embodiment illustrated, users 19a, 19b, and 19c communicate with Internet server 12, first software application 13, or both, through the Internet 18. Users 19a, 19b, and 19c, in this illustration, represent a selection of the users described in more detail herein, for example. In addition, when it takes place, Internet server 12 and intermediate server 16 also communicate via the Internet 18. Users 19a to 19c may enter data into, obtain data from, or both, Internet server 12, first software application 13, modules thereof, or a combination thereof, for example. Data obtained by users 19a to 19c from Internet server 12 through the Internet 18 may include, for example, reports, agreements, specifications, drawings, spreadsheets, tables, information on the status of projects, information on particular customers, or the like, as examples.

In certain embodiments, second software application 15 is an accounting module, and in some particular embodiments, second software application 15 is MICROSOFT SOLOMON, for instance. Further, in some embodiments, first software application 13 is a management application or an online management application, for instance. In some embodiments, first software application 13 is configured to manage a plurality of construction projects. In certain embodiments these construction projects may include, or even be limited to, the construction of a plurality of tradeshow exhibits, for example.

The communication mentioned above, in certain embodiments, includes transfer of information from first software application 13 to second software application 15, processing of the information by second software application 15 into results, transfer of the results from second software application 15 to first software application 13, or a combination thereof. In certain embodiments, the information may be regarding construction projects, for example. In some embodiments, the communication includes transfer of a next sequential job number from second software application 15 to first software application 13, for instance. The sequential job number may be generated by second software application 15, for example.

In various embodiments, intranet server 14 is configured to automatically initiate communication with Internet server 12 at particular times, which may be at periodic intervals of time, for example. For instance, in some embodiments, intranet server 14 is running on MICROSOFT WINDOWS having a Scheduled Task option, and the Scheduled Task option is used to automatically initiate communication with Internet server 12. When communication is initiated, data may be transferred from Internet server 12 to intranet server 14, processed, and transferred back, for example.

In a number of embodiments, system 10, first software application 13, second software application 15, or a combination thereof, further include one or more of a number of software modules. In the embodiment illustrated, first software application 13 includes, as examples, project preliminary module 13a, new client request module 13b, vendor editor module 13c, requisition/purchasing module 13d, time tracker module 13e, and project performance module 13f. Various embodiments may include various combinations of these modules, other modules, or a combination thereof. Also, in this embodiment, second software application 15 includes project maintenance 15a, customer maintenance 15b, vendor maintenance 15c, purchasing 15d, time and entry expense 15e, and project controller—summary and detail 15f, as examples. Various embodiments may include various combinations of such modules or elements or other modules or elements.

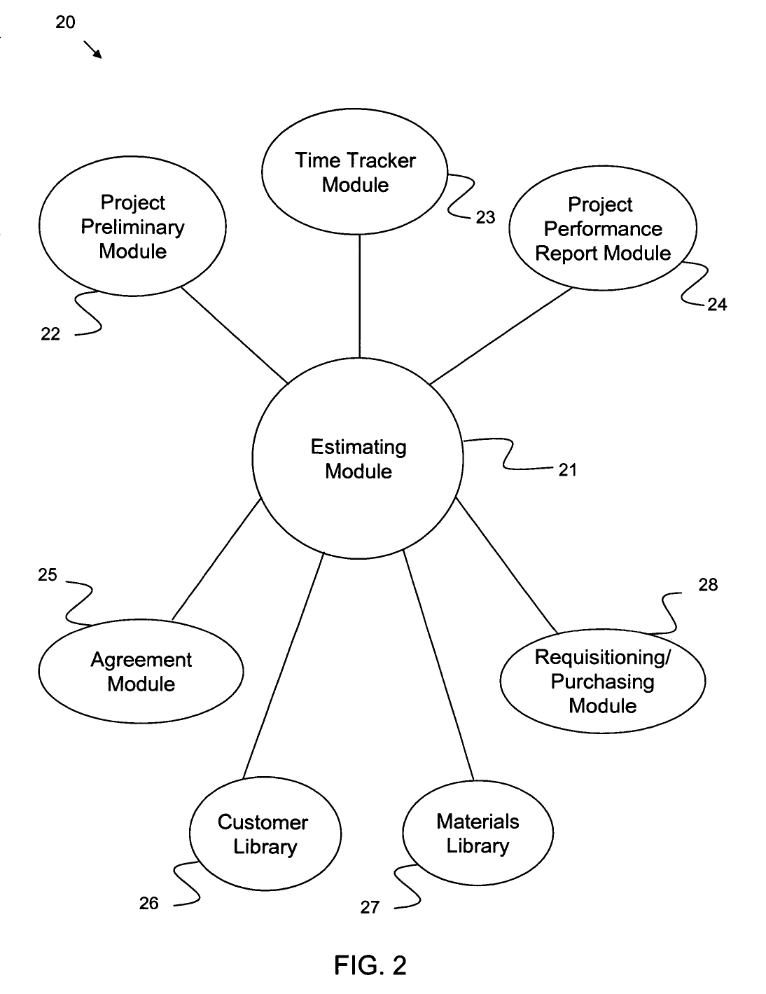

Turning now to FIG. 2, the invention also provides, in a number of embodiments, a computer-implemented or online management system that includes a plurality of software modules. In the embodiment illustrated, management system 20 includes an estimating module 21, which may be configured to be used to estimate the time and cost of projects, for example. System 20 further includes a plurality of other modules which may be configured to perform one or more specific functions. In this embodiment, the other modules are each configured to interface predominantly with estimating module 21 such that estimating module 21 serves as a hub for the other modules within management system 20. In some of these embodiments, data entered initially into estimating module 21 is used to populate fields in at least a plurality of the other modules within system 20. Further, in certain embodiments, data entered initially into estimating module 21 is used to populate fields in all of the other modules.

In various specific embodiments, management system 20 further includes an accounting application configured to perform accounting functions, which may be similar or identical to the second software application 15 shown in FIG. 1, for example. Data entered into estimating module 21, or other modules of system 20, may be transferred to the accounting module, for example, periodically, and information, such as results or raw data, may be transferred back to system 20 from time to time. Further, in some embodiments, system 20 may include or be loaded onto a first server and a second server may be used onto which the accounting application is loaded. Such a first server may be Internet server 12, and such a second server may be intranet server 14, shown in FIG. 1, for example. And further, in some embodiments, an intermediate server, such as intermediate server 16, is used or included that may be configured and arranged to facilitate transfer of information between the first server and the second server.

The other modules of method 20 may include or be similar to modules 13a to 13f described with reference to FIG. 1 and shown therein. In the embodiment illustrated in FIG. 2, the other software modules include project preliminary module 22 which may be configured to facilitate input of information about potential new projects, time tracker module 23, which may be configured to track actual time, actual materials used, and actual cost of the projects, for example, and project performance report module 24, which may be configured to prepare reports that compare estimated cost, material, and time of projects with actual cost, material, and time of the projects. In various embodiments, estimating module 21 uses at least some of the information input into project preliminary module 22, and in some embodiments, such information may be used in other modules as well. And in some embodiments, workers or users are required to input time spent and materials consumed for particular projects into time tracker module 23, for example, on a regular basis to facilitate up-to-date tracking of progress and expenses.

In this particular embodiment, system 20 also includes agreement module 25 which may be configured to prepare an agreement for signature for a new customer, a new project, or both, and requisitioning/purchasing module 28 which may be configured to prepare requisitions and/or purchase orders for obtaining materials, services, or both, for example. These modules may also use data from estimating module 21, which may originally be input into project preliminary module 22, for example.

In a number of embodiments, the management application or system 20 further includes at least one electronic library where information is stored. This particular embodiment includes, for example, electronic customer library 26 where information on a plurality of customers may be stored. Furthermore, in some embodiments, management system 20 further includes electronic materials library 27 where information on a plurality of materials may be stored, which information may include prices of materials. In some embodiments, the information may also include a name or description of the materials, or both. Estimating module 21 may use at least some of the information in materials library 27 for estimating the cost of projects, for example. In some embodiments, actual prices paid for materials may be used to update the prices of materials in materials library 27.

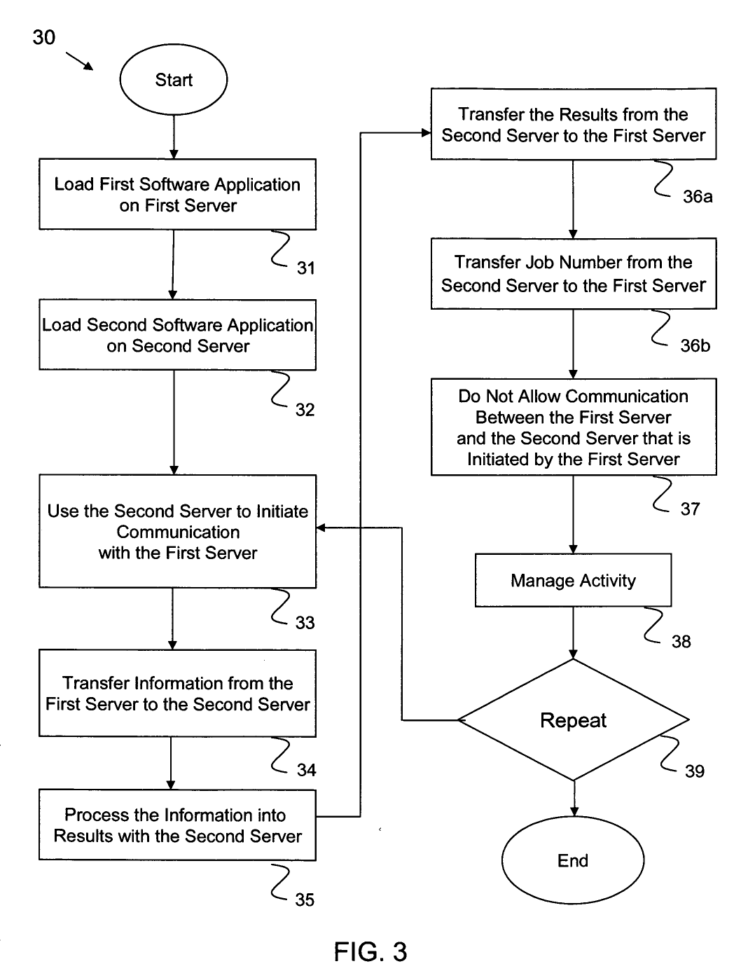

In other examples, the invention also provides various methods, such as methods for transferring data between an Internet server and an intranet server, which may be configured to maintain an acceptable level of data security. FIG. 3 illustrates a flowchart of an example of such a method, method 30. Method 30 includes a number of steps, various combinations of which may be present in different embodiments of the invention. But in some embodiments, certain steps may be performed in a different order than illustrated, other steps may be performed in addition, or both.

In the embodiment illustrated, method 30 includes loading a first software application on a first server (step 31). In some embodiments, the first software application may be first software application 13 shown in FIG. 1, and the first server may be an Internet server, for example, like Internet server 12 for example. Method 30 may also include the step of loading a second software application onto a second server (step 32). In some embodiments, the second software application may be second software application 15 shown in FIG. 1, and the second server may be an intranet server, for example, like intranet server 14. In a number of methods in accordance with the invention, steps 31 and 32 may have already been performed at an earlier time.

Still referring to FIG. 3, various embodiments of the invention include the step of using the second server to initiate communication between the second server and the first server (step 33). In many embodiments, this communication may take place through an intermediate server, such as intermediate server 16 shown in FIG. 1, for example. In some embodiments, method 30 further includes the step of transferring information from the first server to the second server (step 34), which, in some embodiments, is also through the intermediate server. Such information may include, for example, information on new customers, new projects, or the like, for example.

Further, some embodiments of the invention include the steps of processing the information into results at the second server (step 35), and transferring the results from the second server to the first server (step 36a). In addition, in some embodiments, the processing (of step 35) includes performing computations using an accounting application, for example, performing computations using MICROSOFT SOLOMON. Results may include, for example, reports, totals, estimates, or the like. Moreover, in some situations, each job may be given a job number, and these job numbers may be assigned sequentially, for instance. In some embodiments, the job numbers may be assigned by the accounting application, for example. Thus, certain embodiments further include the step of transferring a job number from the second server to the first server (step 36b). This job number may be a next sequential job number, in some embodiments, and in certain embodiments, may be transferred from the intranet server to the Internet server, for example.

Further, some embodiments of the invention include preventing or not allowing communication between the first server and the second server that is initiated by the first server (step 37). In some embodiments, this step (step 37) includes not allowing communication between the Internet server and the intranet server that is initiated by the Internet server. In some embodiments, any communication with the intranet server that is initiated through the Internet or a public or unsecured network may be prevented. Prohibiting or not allowing communication between the first server and the second server that is initiated by the first server (step 37) is shown in FIG. 3 as a discrete step, but the step of not allowing communication between the first server and the second server that is initiated by the first server (step 37) may be performed continuously throughout method 30, for example.

In addition, in some embodiments, not allowing communication between the first server and the second server that is initiated by the first server (step 37) may not be absolute. For example, other communication between the first server and the second server that is initiated by the first server may be permitted where the security risk is low. Thus, as used herein, not allowing communication between the first server and the second server that is initiated by the first server (step 37) may include allowing certain communication between the first server and the second server that is initiated by the first server (step 37) where the security risk is low or the communication is not related to the management of the activity (step 38).

In various embodiments, method 30 further includes the step of managing an activity (step 38), such as a business activity, for example. Such management (step 38) may include-using a management application, which may be loaded on an Internet server, for example. In some embodiments, the managing of an activity (step 38) or a business includes managing a plurality of construction projects, for example, which may include managing the construction of a plurality of trade show exhibits, for instance, in particular embodiments. In some embodiments, an online management system may be used such as described herein.

In a number of embodiments, some or all of steps 33 to 38 may be repeated (step 39). In certain embodiments, some or all of steps 33 to 38 may be repeated (step 39), at particular times, for example, such as at regular intervals of time. Expressed in another way, in a number of embodiments, the step of using the second server to initiate communication (step 33) includes automatically initiating communication at particular times, for example, at periodic intervals of time. For instance, in certain embodiments MICROSOFT WINDOWS, having a Scheduled Task option, is loaded on the second server and method 30 further includes a step of using the Scheduled Task option within WINDOWS to automatically initiate communication with the first server.

How frequently communication may be initiated (e.g., step 33) or repeated (e.g., step 39) may depend on how often it is needed, for example, based on company requirements or work load. In particular embodiments, communication may be initiated every 5 minutes, for example. In some embodiments, the frequency of communication may depend on factors such as time of day, season of the year, and the like, for instance. In some embodiments, the frequency of communication, or time interval between communications, may depend on factors such the number of users accessing a server, or the amount of data being transferred, either at that time or at the time of the previous communication, for example, in different embodiments.

The management of the activity (step 38) may be performed continuously, for example, while steps 33 to 37 are being performed or repeated (step 39). In some embodiments, the step of managing activities (step 38) may be repeated (step 39) for different activities, for example, different constructions projects or different activities therein.

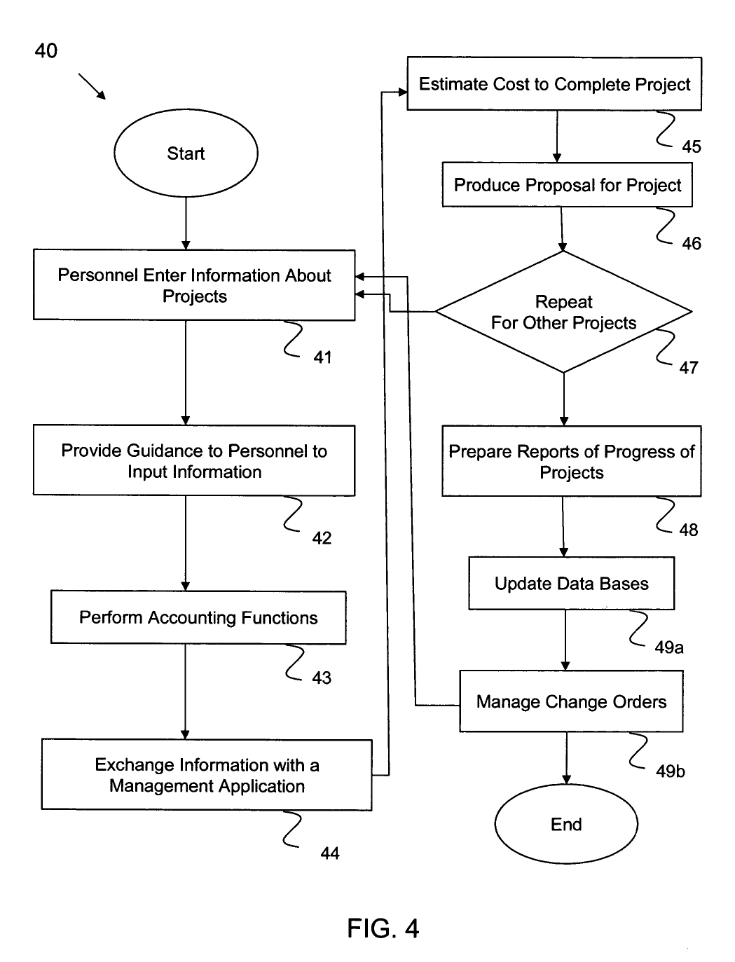

Referring now to FIG. 4, the invention also provides, in yet another example, a method 40 of managing a plurality of projects, such as construction projects, for example. In the flowchart shown in FIG. 4, this particular method 40 includes the steps illustrated, although different embodiments of the invention may include fewer or more steps, which may be in a different order in some cases. In the embodiment illustrated, method 40 includes the steps of personnel or users entering information about projects (step 41) and the step of providing guidance to the personnel to input the information (step 42). These steps may be accomplished using project preliminary module 13a or 22, for example, shown in FIGS. 1 and 2, for example. In various embodiments, at least some personnel may be allowed to enter information (step 41) about new projects into a management application, which may be similar or identical to first software application 13, for example. Guidance may be provided (step 42) by requiring that certain information be entered in order to complete the entry or before proceeding to at least one subsequent step, for instance. This may be accomplished using the management application, for example.

Method 40 also includes the step of performing accounting functions (step 43), which may include, for example, using a computer-implemented accounting application loaded on an intranet server to perform accounting functions associated with certain construction projects. In some embodiments, the accounting function may be similar or identical to second software application 15, for example. In the embodiment illustrated, method 40 further includes the step of exchanging information with a management application (step 44). Such a management application may be, for example, an embodiment of first software application 13 shown in FIG. 1. In particular embodiments, method 40 includes using a network-based computer-implemented management application loaded on an Internet server and configured to be accessed by a plurality of users to exchange information with the accounting application (in step 44) so that at least some of the information will not have to be entered twice for the management application and the accounting application.

As described herein, in some embodiments, the construction projects include construction of trade show exhibits, for instance. Further, in some embodiments, communication between the management application and the accounting application (e.g., in step 44) occurs, or is permitted, only when initiated by the accounting application. And some embodiments further include the step of using an intermediate server to facilitate communication between the management application and the accounting application (e.g., in step 44).

In the embodiment illustrated, method 40 further includes the steps of estimating the cost to complete a project (step 45) and producing at least one proposal for the project (step 46). Certain embodiments include using at least the management application, the accounting application, and the information about the new projects (e.g., entered in step 41), to estimate the cost to complete the projects (step 45). Various embodiments then include the step of using the results of the estimating to produce proposals for the projects (step 46). Producing a proposal (step 46) may include, in some embodiments, producing a price or bid, which may include, for example, a calculation of material costs, labor costs, overhead, profit, and the like. In many embodiments, the proposal (e.g., produced in step 46) may also include information regarding the project, for example, what will be done, how it will be done, etc. In some embodiments, the proposal (e.g., produced in step 46) may include, specifications, drawings, a schedule, pricing, various contract provisions, or a combination thereof, for example. These proposals may then be submitted to the potential clients or customers. Steps 41 to 46, or a combination thereof, may be repeated in some embodiments for other projects (step 47) for which proposals may also be submitted to the potential clients or customers.

Method 40 of FIG. 4 also includes the step of preparing reports of the progress of projects (step 48). Some embodiments include the step of using at least the management application, the accounting application, and the information about the new projects (e.g., entered in step 41), to prepare reports showing progress of the projects (step 48). In some embodiments, these reports (e.g., generated in step 48) may be transferred to the management application (e.g., in step 44), for example.

In the embodiment illustrated, method 40 further includes the step of updating data bases (step 49a). Such data bases may include customer library 26, materials library 27, or both, illustrated in FIG. 2, for example, and the data bases may be updated with information entered in step 41, for instance, in some embodiments. Updating data bases (step 49a) may include updating material costs, updating costs of rentals or services, updating customer or potential customer contact information; updating times or labor required to accomplish particular tasks, updating availability of materials or services, and the like, in various embodiments. In some embodiments, updating these databases (e.g., step 49a) may be performed within the management application or may include transferring information to the management application (e.g., in step 44), for example.

In a number of embodiments, method 40 may also include the step of managing change orders (step 49b). Personnel may enter information about a proposed change order (similar to step 41), which may include guidance provided to the personnel to input information (step 42 or similar). Further, accounting functions may be performed (step similar to step 43) and information may be exchanged with a management application (step 44 or similar). The cost of the change order may be estimated (step 45 or similar) and a proposal may be prepared (step 46 or similar) if required. Change orders may be incorporated into reports of progress (step 48) and information obtained in preparation or performance of change orders may be used to update data bases (step 49a). Steps 48 to 49b may be repeated as needed in many embodiments. Steps 48 and 49a may be repeated at regular intervals, for example.

Next will be described an example of a management application or system which may be referred to as an online management system. Such an online management system may be an example of first software application 13 shown in FIG. 1, management system 20 shown in FIG. 2, or both, for example. In various embodiments, an online management system is an example of an embodiment of the invention that meets certain operating needs of a business which were not previously provided by an accounting application such as SOLOMON FINANCIAL SYSTEM. In this example, the business is concerned with the design, construction, installation, and dismantling of trade show exhibits and the like. However, various embodiments of the invention may apply to other construction activities, other businesses involving particular projects, or other business generally.

In certain embodiments, the system needs may be defined based on various requirements including the need to design, build, deliver, install, dismantle, handle, and store the products of the business, for example. The examples of an online management system described herein are tools that may have some features in common with an estimating template/workbook, for example. Further, a particular example of an online management system described here has been effectively linked with an accounting application, specifically SOLOMON, resulting in a single system providing an effective tool for production and finance, among other things. The accounting application and online management system integrated version may, in certain embodiments, better streamline best practices and policies, analyze and report on the actual operations performance of the company, and identify areas to focus upon for improvement, as examples.

As described, in certain embodiments, an online management system is programmed to complement and link to an accounting application such as the SOLOMON FINANCIAL SYSTEM. Various embodiments at least partially follow a single data entry philosophy. In such embodiments, data may be transferred to a number of appropriate worksheets, avoiding or reducing needs for double or repeated entry by users. In some embodiments, an online management system and an accounting application such as SOLOMON may use the same structured query language (SQL) database language resulting in a compatible environment.

Further, certain embodiments may include project estimating, contracts, or both, for instance. In addition, some systems automatically generate material purchase lists for estimated projects, which may result in greatly reducing potential for error, time to recalculate, or both. Furthermore, in certain embodiments, change orders are automatically linked to estimating, invoicing, or both. And in some embodiments, project close out, reporting, deposit tracking, credit approval, customer control, project control, or a combination of these functions are included, as examples.

Further, various embodiments of an online management system include a comprehensive materials library such as materials library 27 shown in FIG. 2. In such embodiments, this feature may help in purchasing, estimating, design, or a combination thereof, for example, to easily specify products based upon budget and availability. Material usage reports, price fluctuations, reports for national purchase consolidation, volume discounts, or a combination thereof may be functions included in certain embodiments, which may be accessible on a divisional or a corporate level within a business or company, for instance. In some embodiments, materials requiring long lead times may be identified early, and an automatic e-mail may be issued to the project team when such materials are included in an estimate. In some embodiments, an online management system is configured to link to the Intranet, Event Net, a rental Library, FTP, or a combination thereof, as examples.

Certain embodiments of an online management system incorporate at least one of the following processes, functions, or modules: Project Preliminary, D&B Request, Estimating (fabrication, graphics, transportation, events etc), Proposal, Production Order, Shipping Orders Component List, Shipping/Receiving, Bill of Lading, and Invoicing. Some embodiments of the invention include all of these modules. In various embodiments, the above are configured on a central data base to facilitate critical analysis, reporting on a company wide basis, or both, as examples.

Various embodiments of an online management system provide certain security measures. For instance, certain embodiments have a customized “User ID” and “Password” for some or all users. In some embodiments, users can create their own User ID and Password. And in some embodiments, a two stage accessibility system in an encrypted format is used, which may create a very difficult decoding process for unauthorized users. Some embodiments of the invention include a built in module “Log Viewer”, for example, inside an online management system, which may track users, unauthorized users trying to gain accessibility, or both. In certain embodiments, alarms are triggered to a system administrator to advise of possible intrusions.

Further, in some embodiments, a module may also track certain changes made to the module or worksheets. This may provide information regarding which IP address was changed, time and date and location of changes, whether changes are legitimate, or a combination thereof. In various embodiments, a built-in user editor may determine accessibility of the system to users based on their job description, for example. This may prevent users from being able to enter restricted areas, which may minimize errors, tapering of sensitive data, or both.

A variety of embodiments further include an approval process. In a number of embodiments, a new estimate, proposals, purchase orders, labor hours entry, or a combination thereof may be subject to an approval system that may be multi level. In many embodiments, a system tracks the approval process for later reference. Further, selected embodiments include software installed on a secure server. In addition, in some embodiments, ASP pages may be encrypted to avoid tampering of data in transit from user to server, for example. Several embodiments use 128 digit encryption to resist tampering, for example.

In particular embodiments of the invention, as described, both an online management system, and an accounting application, such as SOLOMON, use SQL database systems. This may create compatibility and transferring of data may be fairly efficient. In some embodiments, by using MICROSOFT Data Transformation Services (DTS), programming data can be transferred via an invisible link between the two systems. Data may be transferred using DTS without requiring user interaction in performing functions, which may greatly reduce intrusions or tampering with data. In a particular embodiment, one process is to access and write data from an online management system to an accounting application such as SOLOMON. This may facilitate integrity of the accounting application since users may not be able to tamper directly with data in the accounting application. Various processes, like getting a new job number, getting a new purchase order number, uploading time entry, uploading invoice amounts, or a combination thereof may be performed.

In some embodiments, some users do not have access to some functions such as certain accounting functions. Human relations (HR) functions may be included in various embodiments, which may facilitate obtaining reports and real time project status checks, for example. In select embodiments, an online management system and an accounting application such as SOLOMON may be independent systems. In such embodiments, in an event where the online management system is down, the accounting application, such as SOLOMON, may function as usual, or at least to some extent. Similarly if the accounting application is down, the online management system may function at least to some extent, for example, except for getting job numbers or purchase order numbers in some embodiments. An online management system may be further configured in some embodiments so that in a scenario of such occurrence an online management system can proceed with a function or proceed and continue with a window of entering data back in when the accounting application such as SOLOMON is back up and running.

In some embodiments, some or all jobs to be created in project preliminary, by a selling division for example, may require particular information in order to proceed. This may provide structure or guidance to personnel and assure that all of this required information is obtained and entered at that time. In certain embodiments, the producing division, selling division, or both, may add a new project team by selecting an “add” button, for example, in project preliminary, which, in some embodiments, may be available in a drop-down menu. Further, some embodiments may include a design request form to communicate with a design department. In certain embodiments, the design request may be copied to an estimator, for example, for scheduling of estimating. In some embodiments, estimate requests must be entered into “Estimating” or an estimating module with appropriate line items, which may include itemizing components with detailed descriptions, size, finish, quantity, or a combination of these, for example. In some embodiments, production costs may be entered for such line items.

Various embodiments of the invention include an estimating principal, an estimating worksheet, or both. In some embodiments, an estimate or line item given to another division without a value may automatically change to the other divisions worksheet. In some embodiments, for particular items, the creator who inserted a value to the worksheet may be the sole editor, and others may only be allowed to review that item. In certain embodiments, some or every estimate must be approved to create a proposal. In various embodiments, proposals may or must be created through an online management system using a subtotal function, which may allow various options with which to collate appropriate presentations to a client. In more than a few embodiments, a sold job may or must be booked in job entries to initiate production, which may include remaining project information and actual sale prices for building and showing.

In some embodiments, a production order may be created for booked jobs. A production order may be created to further detail the scope of work for a line item component and, in some embodiments, can only be done by selecting the appropriate line item. A number of embodiments may accommodate change orders for tasks, for example, additional to the approved proposal. A change order, when created, may be sent as an estimate request, which may be available to determine allocated time, material, or both, for example, for invoicing. In a quantity of embodiments, time and stock materials incurred may be entered through a time tracker for booked jobs to the appropriate line items. Various embodiments can also produce a time tracker collation report, for example, detailing hours and material per day, for a particular day, a particular department, all departments or for a project or overall projects, for instance. In some embodiments, material and service purchased through material requisitioning are sent to a purchasing agent and certain embodiments will also notify the creator of the status of a request.

Various embodiments provide or show a site labor schedule created through a labor order form which may be made available to central planning, for example. In some embodiments, deposit, final, and credit invoices may be created and approved in an online management system as well. Deposits received may be entered into an invoice receiving module for accurate balance payment calculations. Further, in particular embodiments, some or all pages in an online management system can be e-mailed either “page send by e-mail”, “send link by mail”, “send e-mail” or other special e-mailing functions pertaining to particular modules.

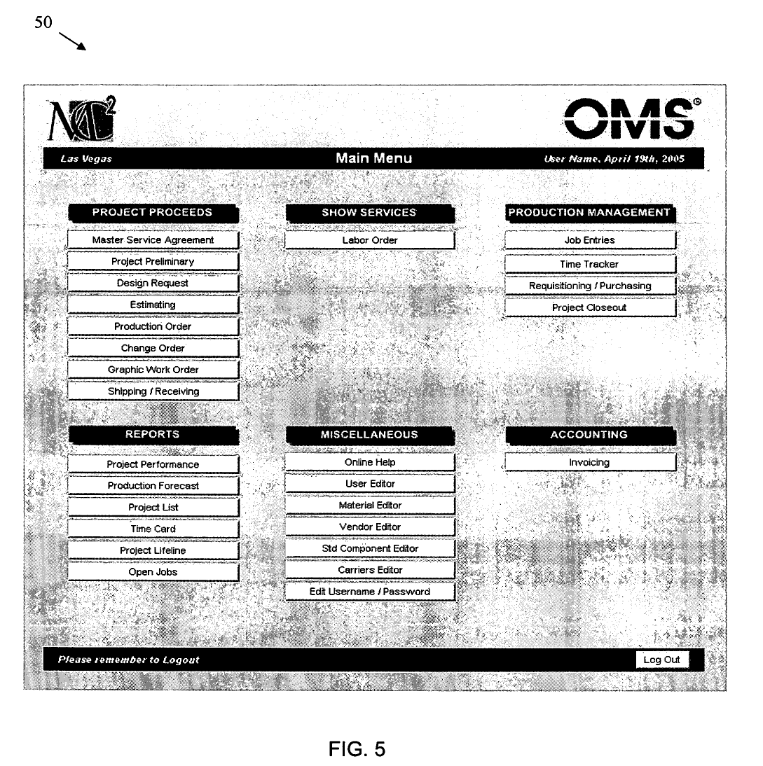

FIG. 5 is an example of a screen shot of a main menu 50 of one embodiment of a management application. This menu also illustrates a number of the functions or modules that may be performed in various embodiments of the invention. Many of these functions or modules are described in more detail below or elsewhere in this document. The following are detailed explanations of a number of the modules or functions shown in the above screen shot of FIG. 5 in one embodiment of a management application in accordance with the invention. In various embodiments, the Master Service Agreement module is used to create a master service agreement (MSA). The details may be entered into a template form, after completion of which users may be able to print the document, which may be automatically page formatted. In some embodiments, there are options to export and import the document to a word processor such as MICROSOFT WORD for additional editing. In some embodiments, the data entered in this module does not carry over to other modules.

In a variety of embodiments, the Project Preliminary module is the starting point of the online management system. Information related to the project may be entered in this module and on submission may be upload into an accounting module such as SOLOMON, which in return may write back the next sequential Job number. Also included in certain embodiments of this module is New Customer Request form. Particulars of a prospective customer may be entered in this New Customer Request form and sent to accounting for review. On approval a new customer file may be created in the accounting application and may be automatically downloaded to the online management system where a user may be able to select and open a new project.

In addition, in a number of embodiments, the Design Request module may be used to enter a description of a design to be conceptualized. Such a description may include client specifications and other key information for designing an exhibit or environment, for example. Also included in this module in certain embodiments is a Pre Design Worksheet. This worksheet may be used to calculate the actual design budget, based on an initial client budget, for example.

Further, in some embodiments, the Estimating module is a combination of up to three sub-modules: Estimating, Review Estimate and Review Proposal. The Estimating module may be considered the backbone of particular embodiments of the system. In certain embodiments, this module provides information for calculating a Sell Price, Cost, Time and Material Entry, or a combination thereof, and may include Purchasing and some or all Reporting. The Estimating module may be where line item descriptions are entered and worksheets are assigned. In some embodiments, the line items can be estimated using materials from the library, for example, as described herein. As the estimate progresses, the Total Price, Total Cost, Contribution Margin, or a combination thereof, may be calculated.

Estimating intra-company, locking and approving an estimate, and assigning components of an estimate to be either estimated or produced by an Intra-Company, or a combination thereof, may be functions of the estimating module in various embodiments. Review Estimate may be, in some embodiments, a replica of the Estimating module with only a review option. In some embodiments, data for the worksheets or line items cannot be changed in this module. Review Proposal is, in some embodiments, where an approved estimate is converted into a proposal. In some embodiments, a Sub Total option may be selected to rearrange line items, apply taxes, open and close statements, or attach a contract, an agreement, payment terms, a time line, graphic production guidelines, a credit card authorization form, or a combination thereof, for example.

Production Order, in certain embodiments, is the module that creates an authorizing document for production to start. In some embodiments, process and producing may be required to adhere to the details of this document. This module may be used to create documents to communicate to production departments of the scope of the project, specifications of finishes, sizes, quantity, or a combination thereof, for instance. Other information such as completion date or special instructions may also be communicated through this module in various embodiments.

The Change Order module, as the name implies, is used to manage change orders. In assorted embodiments, any additional work performed or to be preformed beyond the scope of the original agreed contract will require a change order. The worksheet of this module may be linked to the estimating and invoicing modules in certain embodiments to facilitate an accurate billing description. Also, work executed based on a change order may be, in some embodiments, recorded independently by Project Time Tracker.

In particular embodiments, the Graphic Work Order module creates the authorizing document for graphic production to start the production process. A Graphics department may be required to adhere to the details of this document. This module may be used to create documents to communicate to a graphic production department the scope of the project, specifications of finishes, sizes, quantity, or a combination thereof, for example. Other information, such as completion date or special instructions may also be communicated through this module.

In certain embodiments, a Shipping/Receiving module may also be used to create an authorizing document for a traffic department to ship booth or client products, to arrange trucking, or both, for example. In some embodiments, a delivery date, ship date, shipping locations etc., may be communicated through this module. Further, in selected embodiments, Labor Order produces an authorization document for an Installation and Dismantling (I&D) Department. This form may be used to create a labor schedule for setup, installation, and dismantling, for example. Special show instructions, tools, machinery, or the like required for the setup process may also be identified in this form in some embodiments.

In a range of embodiments, the Job Entries module or worksheet may be used to activate a project on approval of a proposal. Specifically, on approval of a proposal by a client, production may be initiated by accessing Job Entries and assigning a project manager (PM), Detailer, Start Date, Finish date, or a combination thereof, for example. On activation, E-mails may be sent automatically to the appropriate department personal in certain embodiments. Also included in some embodiments is the production cost allocation by department. On assigning a booked job, in some embodiments, this module will show if a deposit is received, and also based on the ship date, balance payment may be provided to the account executive (AE), account manager (AM) and accounting, for example. In some embodiments, some or all of the fields may be related in this module to the Project Preliminary worksheets.

In certain embodiments, a Time Tracker module is where personnel enter time spent on individual projects on a regular basis, for example, on a daily basis. In some embodiments, personnel, such as from Production, may enter stock materials used, which may also be on a regular basis, such as daily. In various embodiments, the labor time and materials cost may be computed and entered into the Project Cost Report, for example. In some embodiments, the number hours worked per week, for example, may be used for production forecasting. For example, the number of hours used in one day or week may be used for forecasting the number of hours that will be needed in the following day or week. In some embodiments, the daily labor hours and stock material used for a project may be entered. And in various embodiments, the cost associated with the labor and materials may be compared to the Job Cost for the project.

In some embodiments, some or all purchasing for a project may be done through a Requisitioning/Purchasing module, workbook, or worksheet. In various embodiments, by submitting a requisition, an e-mail is send automatically to the PM, Detailer, purchasing agent, or a combination thereof. The Purchasing agent may then have the choice to order materials at that time or save that task for later. In certain embodiments, ordering or receiving the materials triggers an e-mail to the PM and Detailer on the status of the requisition. Further, in some embodiments, this worksheet may facilitate generating purchasing requests.

In certain embodiments, a Project Closeout module will create a project report which may include line items identifying positive and negative aspects which affected the project. Independent task categories may also be identified based on estimated and actual production cost, for example. In some embodiments, this module may create a graph showing the pattern of labor hours, other expenditures, or a combination thereof. Further, in some embodiments, a Project Performance Report module may compute production hours, which may be calculated per department per week, for example. In certain embodiments, this module shows whether projects are booked or not booked. Hours may be calculated automatically based on the start date and finish date of each project, for instance. Some embodiments may include a graph of the above forecast, for example.

In various embodiments, a Production Forecast module may be configured to create a forecast of upcoming jobs. Jobs may be grouped into booked or un-booked jobs, for instance. In some embodiments, this module may further provide a history of work flow. And in select embodiments, a Project List module is used to create reports based on project managers, project completion date, project closing date, project start date, division, or a combination thereof, or the like. Further, in certain embodiments, a user can use a Time Card module to display and print their daily or weekly time cards. In some embodiments, certain individuals, such as department managers, can display and print time cards for some or all users, for example, of their department. Moreover, in a number of embodiments, a Project Lifeline module displays a graphics representation of estimated verses actual hours.

Furthermore, in a range of embodiments, an Open Jobs module displays all open Jobs, which may be sorted according to the divisions, for example. This may helps to identify Jobs which can be closed. Still further, in some embodiments, an Online Help module features frequently asked questions, information regarding updates and new releases, and the like. In certain embodiments, the Online Help module is configured to communicate with an information technology department (IT) for suggestions, to report a bug, or to ask specific questions on functions of modules, for instance. Even further, in a number of embodiments, a User Editor module serves to streamline accessibility and visibility to modules or worksheets based on individual user requirements. This module may be used to create accessibility options for users. In some embodiments, users can be given rights ranging from creating estimates, to only reviewing estimates, or proposal to administrative rights. In certain embodiments user names, passwords, and access codes are all set up in this module.

In certain embodiments, a Material Editor module allows a user to add, edit or delete materials from one or more databases, for example, such as materials library 27 shown in FIG. 2. In addition, such a database may be used for estimating and project time tracker, for example. In some embodiments, added materials may be used for specialty products, and information may be added to analyzing their cost and availability. In various embodiments, a Vendor Editor module is where vendors are stored, which may have been exported to the online management system from the accounting application. When users create a purchase order (PO), the materials selected and the vendor to whom the PO is released may be defined in this module. In some embodiments, this module is just a view only database, as all editing is done at the accounting application end.

In various embodiments, estimating commonly used components can be pre estimated as a standard component with the Standard Component Editor module. These components can be inserted into an estimate which will provide consistency and time saving. Further, in a number of embodiments, a Carriers Editor module is used to store information regarding carrier vendors used for shipping booth or customer properties. In certain embodiments, a Edit User Name/Password module is used by users to change their username and password on a periodic basis to enhance the security of the system. In addition, in a selection of embodiments, an Invoicing module collates the Invoicing workbook by inputting data from the proposal and any change orders with agreed pricing. In some embodiments, this module identifies deposits and balance payment.

As mentioned, FIG. 5 illustrates main menu 50 of a particular embodiment of an online management system. In this embodiment, main menu 50 is the first screen presented after users have successfully logged in. Main menu 50 is divided into six sections. In some embodiments, users can only view buttons for modules which have been set up for them. In particular embodiments, only divisional administration users can select the User Editor button, for example. The User Editor module is where new users are added and user rights for existing users are setup. In some embodiments, Main Menu 50 is set up with a time lapse cookie tracking feature. Thereby, users only have to log in once in a particular day.

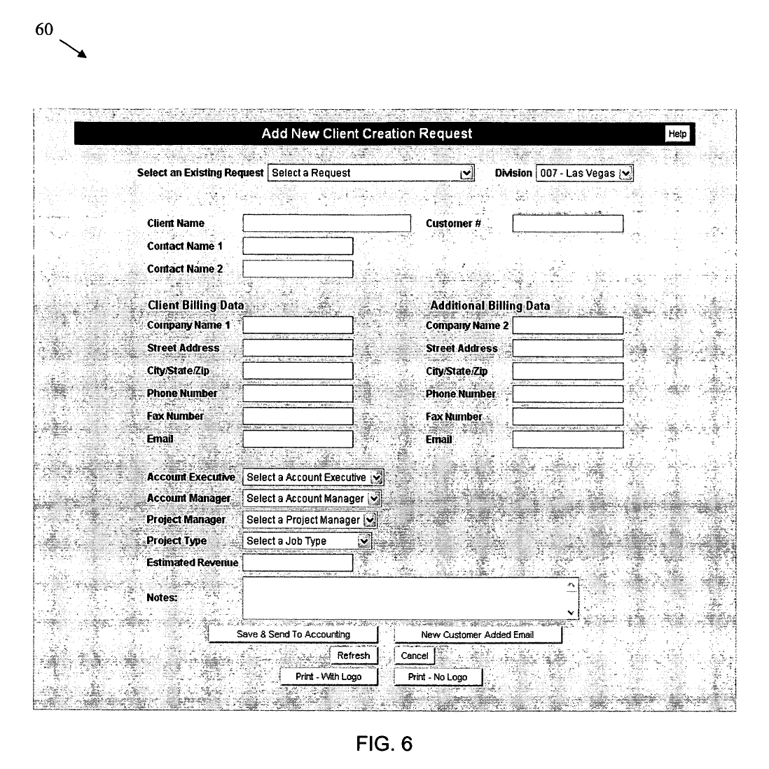

FIG. 6 illustrates an example of a screen shot of a page titled: Add New Client Creation Request (page 60). In some embodiments, this form is used to enter details for creation of a new customer. After completing the form, in this embodiment, the user selects “Save & Send to Accounting” which sends an e-mail with the details to the corporate and divisional controller. Also in this embodiment, after analysis and upon approval, the controller creates a new customer file in an accounting application such as SOLOMON and then selects the “New Customer Added” button to send a notification e-mail to the Account Executive and the Account Manager that the customer has been added. In this particular embodiment, to provide guidance New Customers are not available in the Project Preliminary module where users select a customer to create a new Project unless this form is completed and approved.

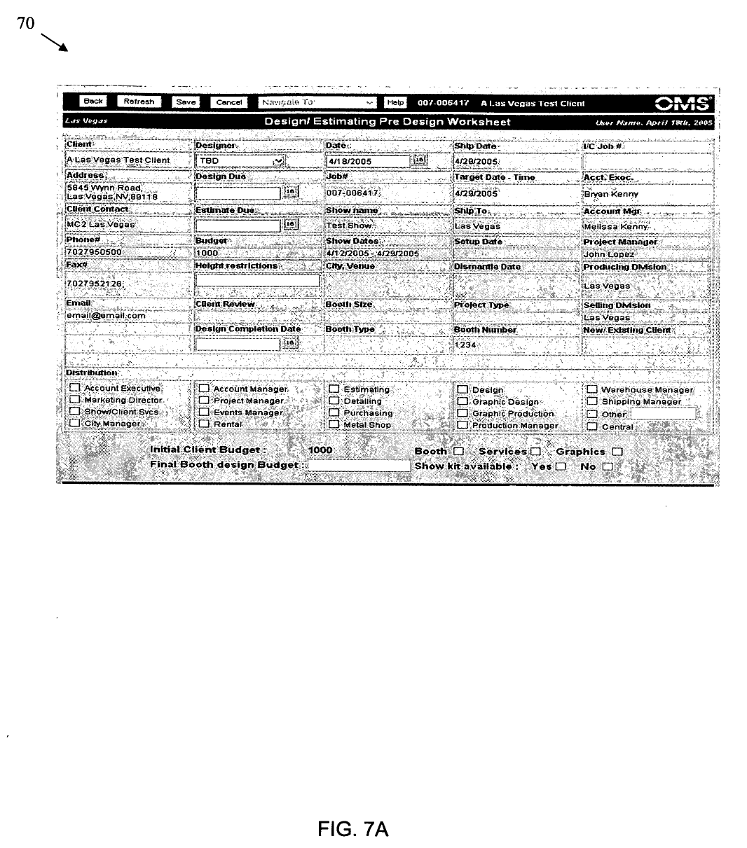

12 FIGS. 7A and 7B illustrate an example of a screen shot of a page 70 titled: Design/Estimating Pre Design Worksheet. FIG. 7A shows the top part of page 70 and FIG. 7B shows the bottom part of page 70. In this embodiment, page 70 is a calculation form used to determine the actual design budget for a turnkey project, for example. The form may help designers to get a more realistic budget based upon which a concept could be developed, for example. This form (page 70) has mathematical formulas, in this particular embodiment, embed in the background which helps determine the Final Booth Design Budget based on Initial Client Budget and on entering additional cost values, for instance.

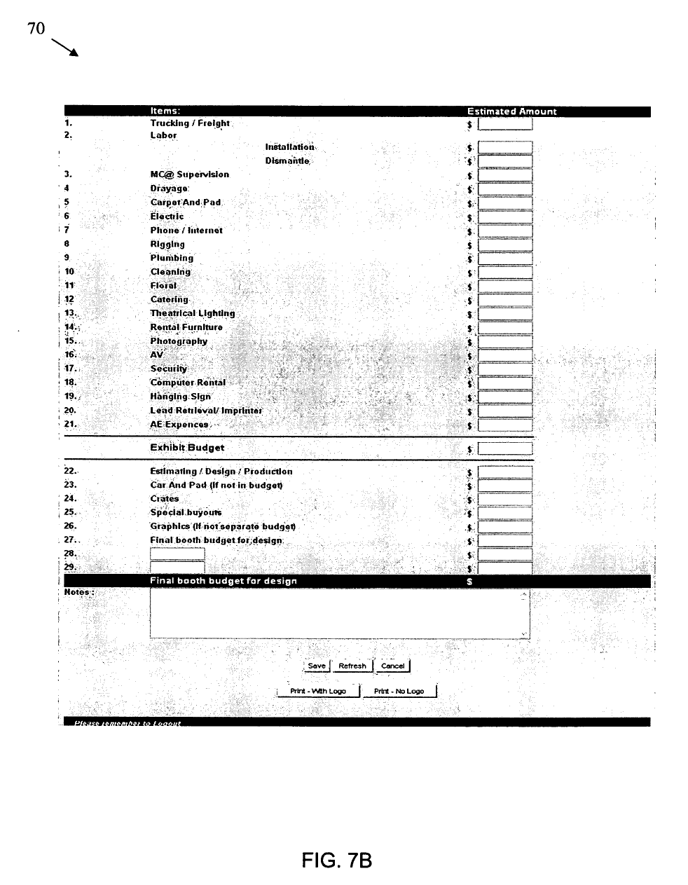

FIG. 8 illustrates an example of a screen shot of a page 80 titled: Project Time Tracker. This form (page 80) may be used to enter time and stock material for a project. In this embodiment, this screen (page 80) is linked to an accounting application such as SOLOMON, Time and Expenses for Project module, and Journal Entries module. Time is entered in this embodiment by selecting a Job from a drop down menu, selecting the Task Code, the Department, and whether rates are Standard (Std.), Over Time (OT), or Double Time (DT), for example.

The stock materials used can be entered into page 80 of this embodiment by selecting the Add Material button and selecting single or multiple materials from the stock material library for example. This material library may be similar or identical to the material library 27 shown in FIG. 2 for example. An uploading function may be simplified by selecting the “Save Upload Solomon” button of this particular embodiment. In some embodiments, the screen (page 80) provides a single entry process whereby the financial system (an accounting application such as SOLOMON) and the payroll system (ADP) can be linked together. The screen (page 80), in some embodiments, provides daily and weekly reports by project, department, hours and material, for example.

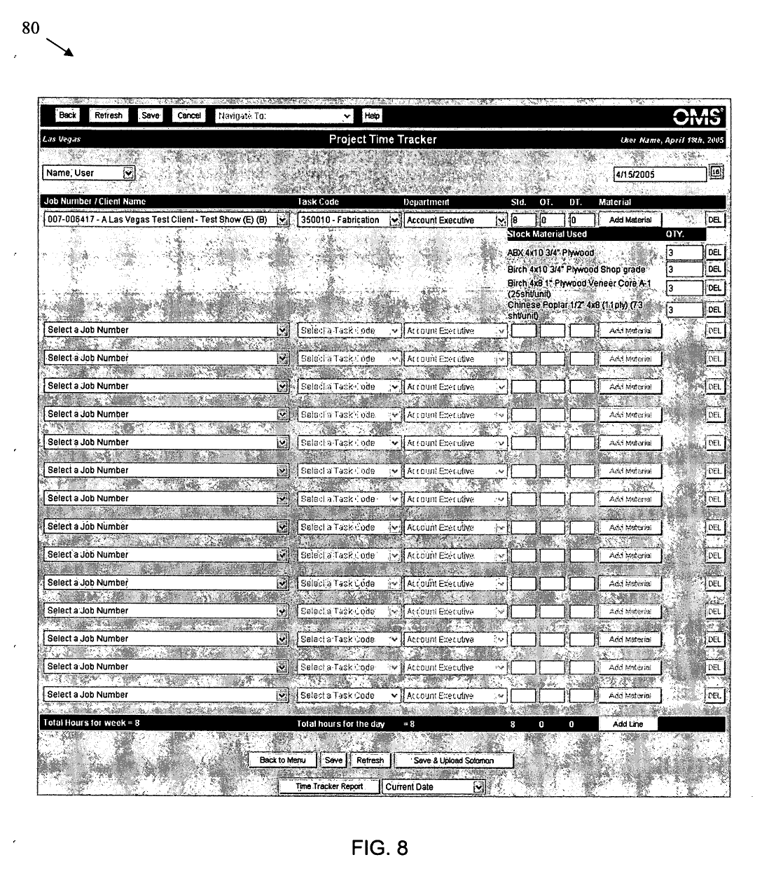

FIG. 9 illustrates an example of a screen shot of a page 90 titled: Select a Material. This screen (page 90), in this embodiment, collates all materials marked as stock material. This screen also relays back information to a database for a complete stock inventory management, in this embodiment. This database may be similar or identical to the material library 27 shown in FIG. 2, for example. The screen (page 90), in this embodiment, allows a user to select multiple materials and insert them into the Time Tracker screen. This screen may also have intelligence to gray out previously inserted items per job, thereby eliminating the need for double entry, for instance.

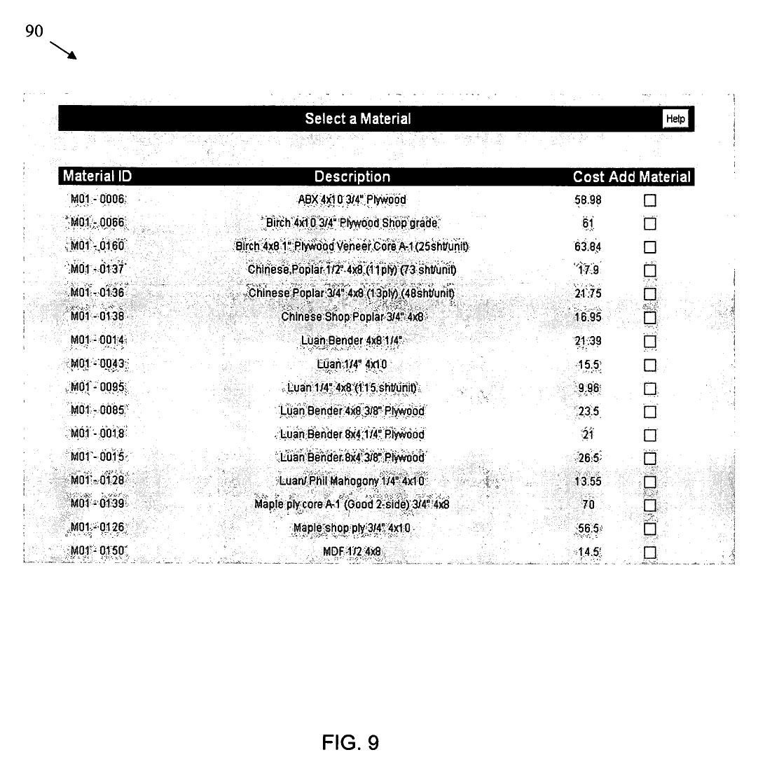

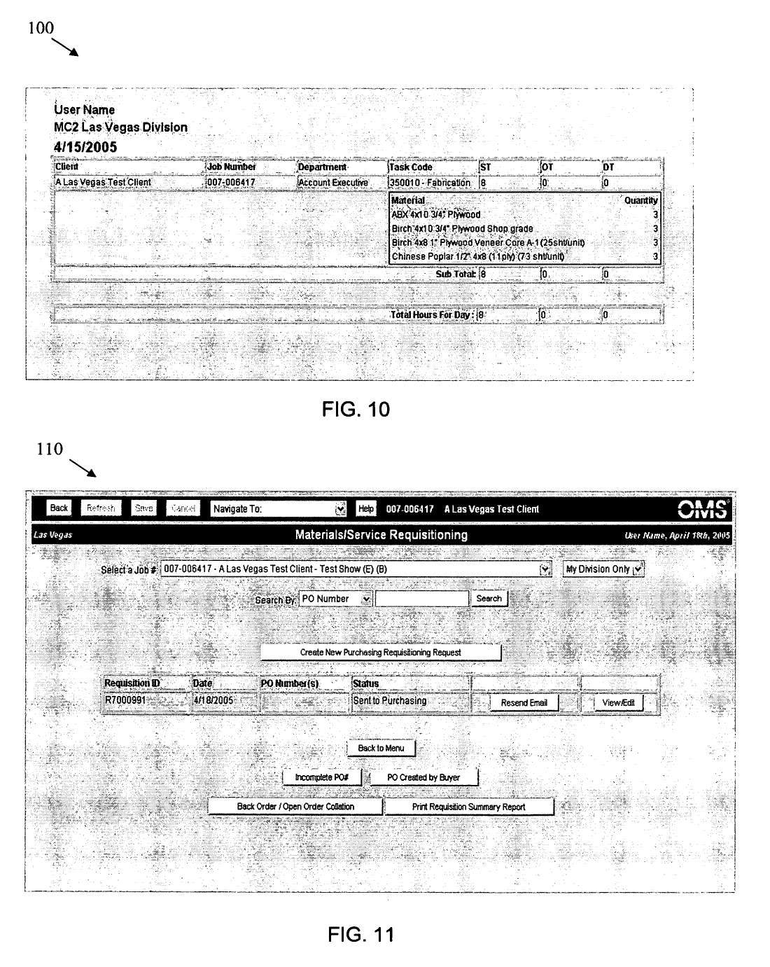

FIG. 10 illustrates an example of a screen shot of a page 100 titled: Project Time Material Entry report. This is a report print for a current day for a single user. In this embodiment, this report shows hours and materials used for a particular job, for instance. FIG. 11 illustrates an example of a screen shot of a page 110 titled: Materials/Service Requisitioning. In some embodiments, this is the main screen of the Requisitioning/Purchasing module. A user selects a Job from a drop down list, on which will be displayed some or all existing or requested information created for the selected Job. In some embodiments, a User can create a new request, or search for an existing request based on purchase order (PO) number, Requisition number, or Item identification (ID) number, for example. This screen may link to screens to view PO's created by buyers, incomplete PO's, etc. Back order and open order reports and summary reports may also be provided through this screen in some embodiments.

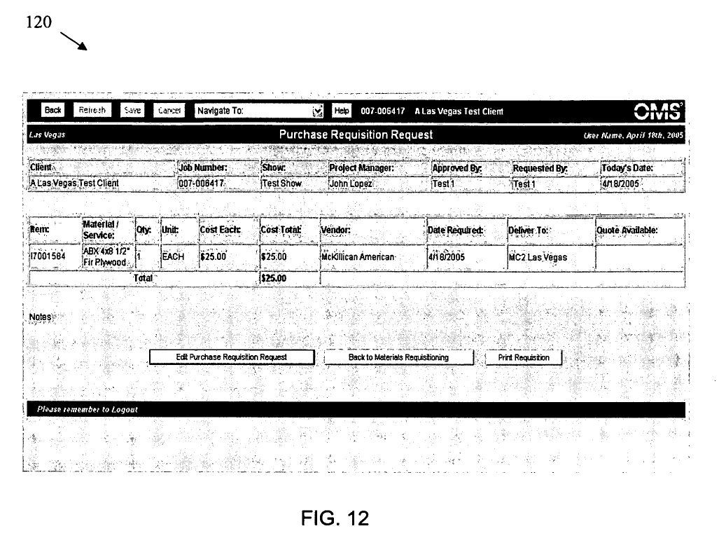

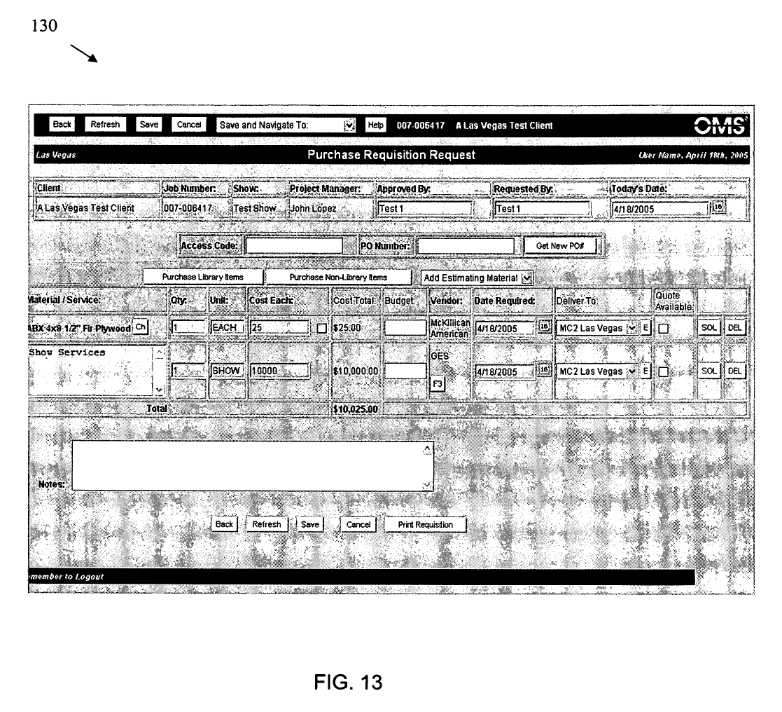

FIG. 12 illustrates an example of a screen shot of a page 120 titled: Purchase Requisition Request: In some embodiments, upon selecting a View/Edit button, this screen is displayed with details of the request. From here, the user, if the user has appropriate user rights, would be able to edit the request and convert the request into a PO in some embodiments. A User may also be able to print the summary to view the details and also to review the estimated verses actual cost. FIG. 13 illustrates an example of a screen shot of a page 130 also titled: Purchase Requisition Request. In some embodiments, a user may use this screen to enter details of the materials or service to be purchased. The request may be created by either selecting “purchase library material” to purchase material or services which are in the material library, or “purchase non-library items” to purchase materials or services which are not available in the library. In this particular embodiment, a User can create as many needed line items for the various requirements, and finally would select the “save and send to purchasing” button to send an e-mail notification to the purchasing agent, who would then convert the request to a purchase order and upload the data into an accounting application such as SOLOMON.

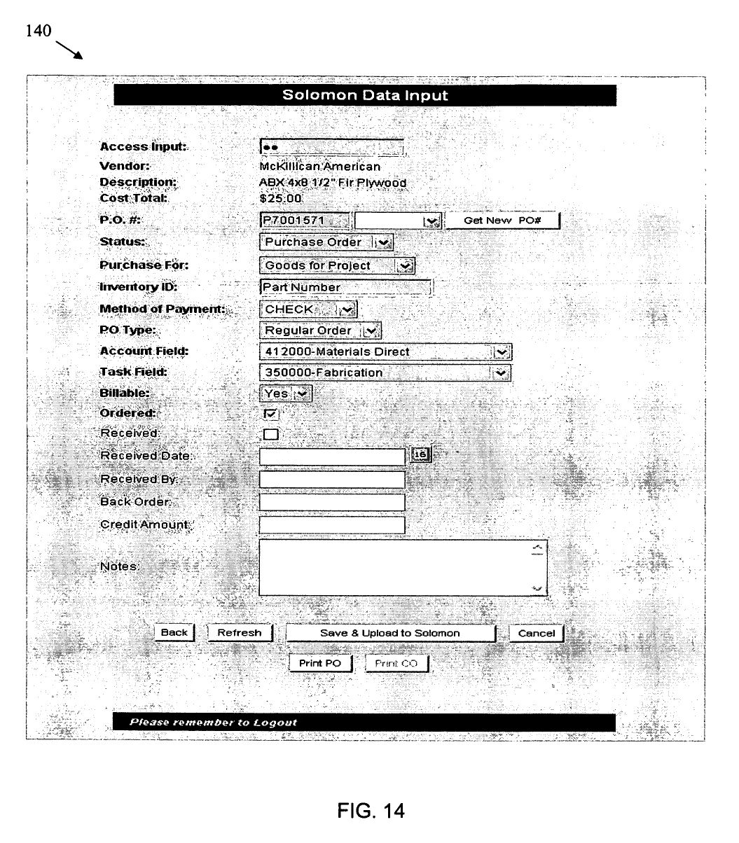

FIG. 14 illustrates an example of a screen shot of a page 140 titled: Solomon Input Data. In some embodiments, a purchasing agent, upon receiving a request from a user, may select the “sol” button and complete the required information in the screen shown below. Purchasing agents, in some embodiments, require a unique access code to complete this form and get the next sequential purchase order number. Upon completion, the purchase agent may select the “save $ upload Solomon” button to complete the purchase order creation and to upload the data to SOLOMON. Other embodiments of the invention may use an accounting application other than SOLOMON.

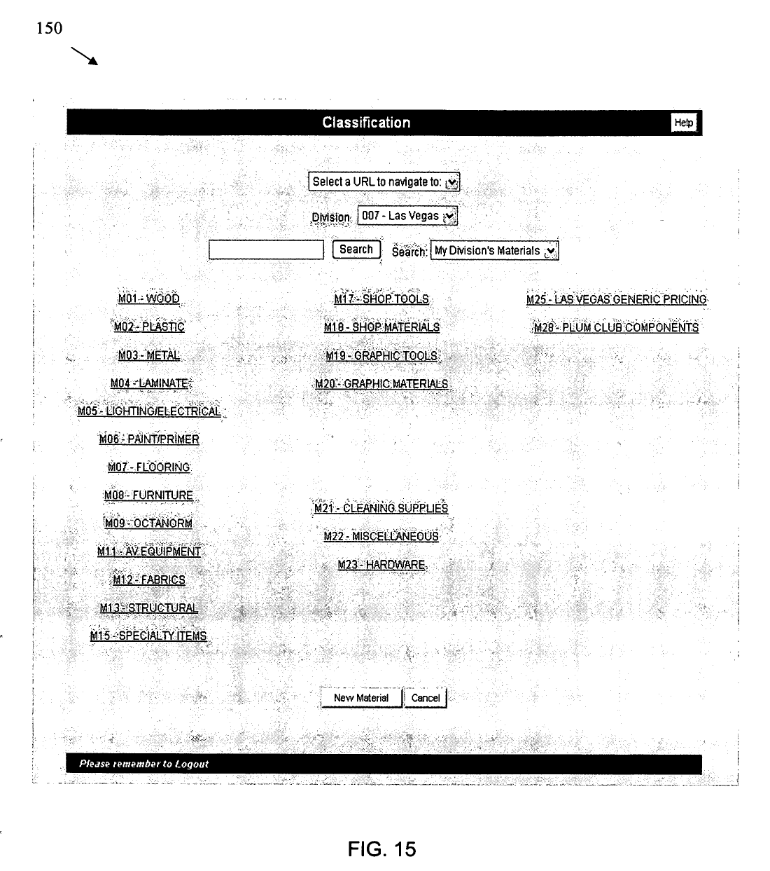

FIG. 15 illustrates an example of a screen shot of a page 150 titled: Material Library and Classification, or just Classification. In some embodiments, on selecting the button “purchase library items” this screen is displayed. The user can select a material or service stored under the desired classification. Alternatively the user can search for the item in all classifications within the users division or all company locations, for example. A new item can be entered to be part of the library form this screen also, in some embodiments.

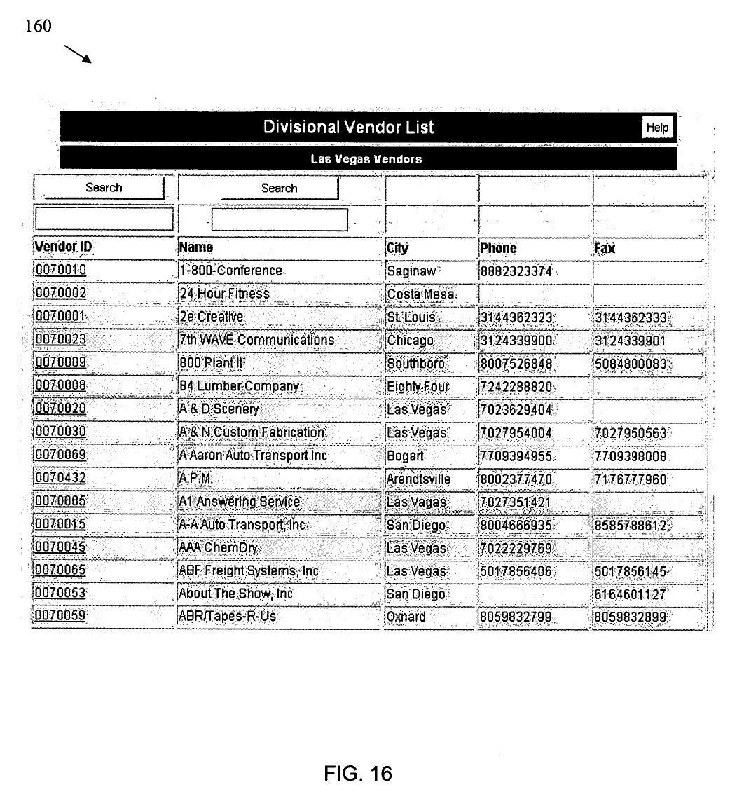

FIG. 16 illustrates an example of a screen shot of a page 160 titled: Divisional Vendor List. In some embodiments, selecting the “purchase non-library items” button will initiate a request for selecting a Vendor from the Vendor List. In certain embodiments, all Vendors are created or edited in an accounting application such as SOLOMON and on completion will upload to the online management system. In particular embodiments, a new vendor creation has to be requested and in most cases divisional accounting would create the vendor in the accounting application. In a number of embodiments, divisional accounting can block selecting of desired vendors based on company policy.

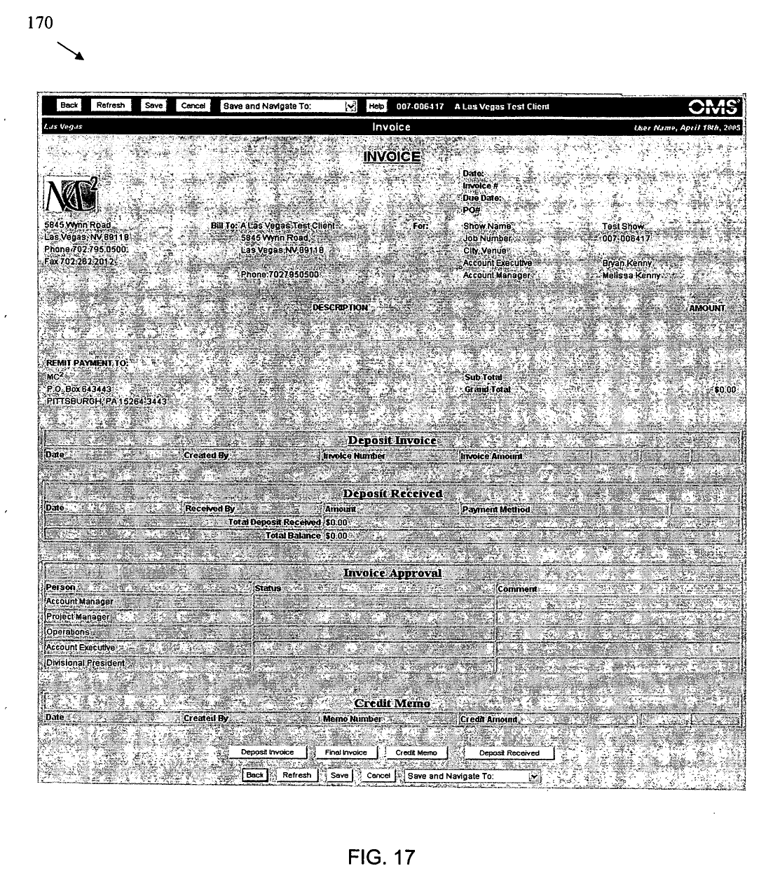

FIG. 17 illustrates an example of a screen shot of a page 170 titled: Invoicing or Invoice. In some embodiments, this module is used to create invoices such as deposit invoices, credit invoices, and final invoices, and also has a deposit received tracking sub module in certain embodiments. This module or page may integrate with an accounting application such as SOLOMON whereby the created invoice will upload to the accounting application and all received payments would download to an online management system, for example. In particular embodiments, this module automatically collates some or all line items from the contract and also some or all change orders. In various embodiments, users can collate the invoice using a combination of line items and free form entries, for instance. Further, each line item of an invoice can be setup up for independent tax rates in some embodiments.

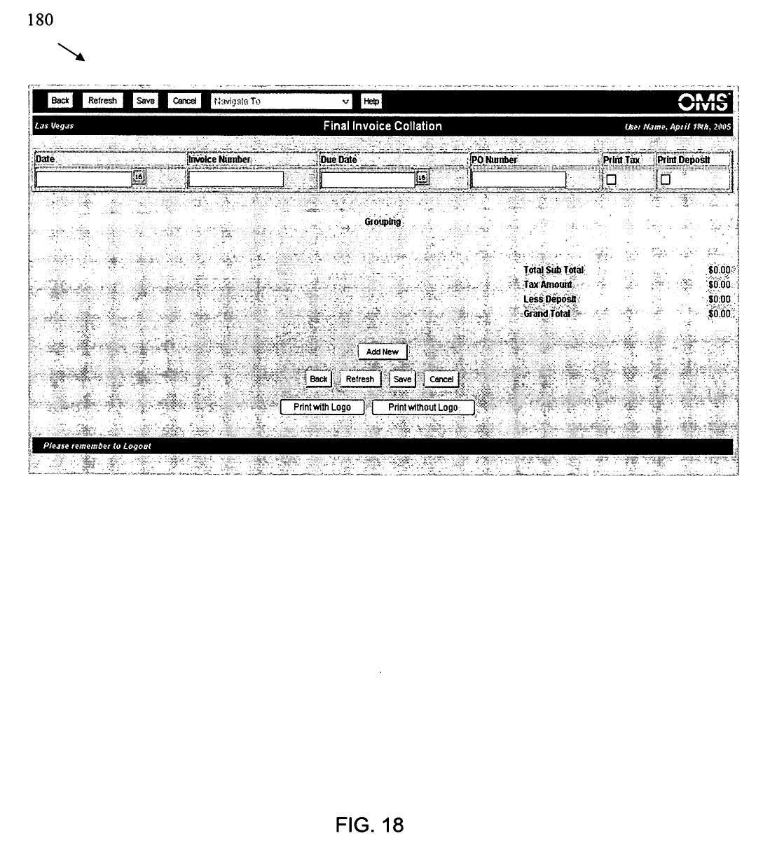

FIG. 18 illustrates an example of a screen shot of a page 180 titled: Invoice Collation or Final Invoice Collation. In many embodiments, this screen is used as a starting point for invoice creation. In these embodiments, the basic invoice information may be required to be entered. A User can create multiple groupings of an invoice, in some embodiments, and in this screen all groupings are shown to later view or edit, for example.

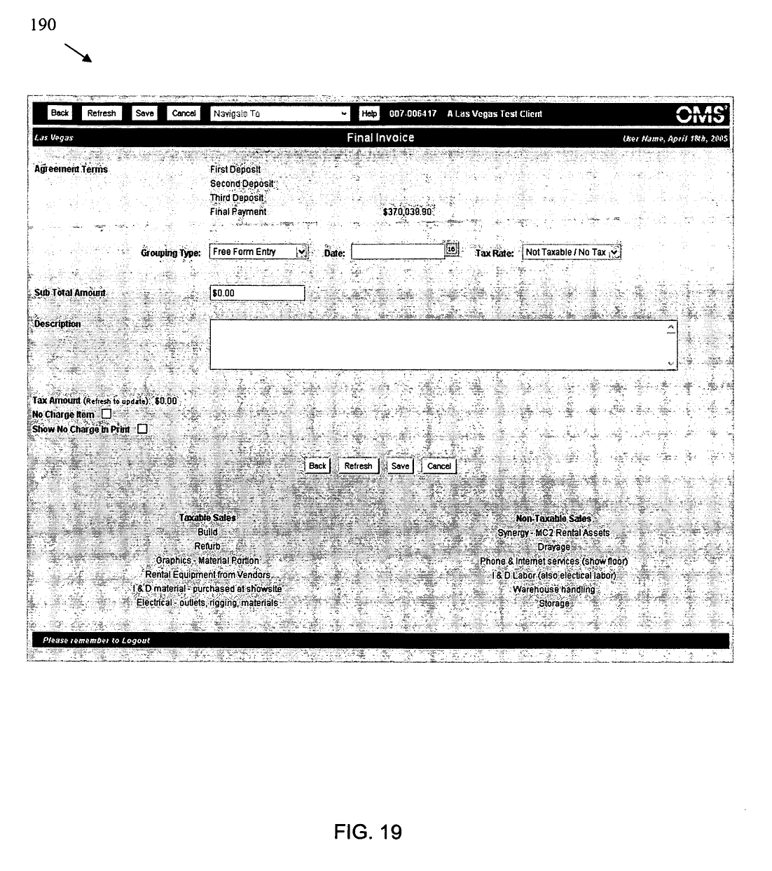

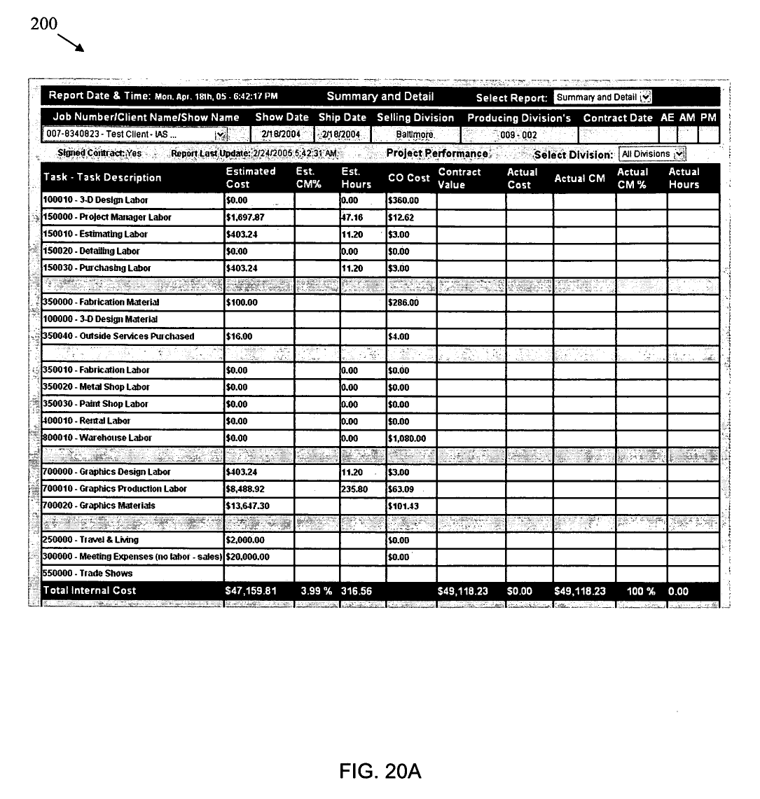

FIG. 19 illustrates an example of a screen shot of a page 190 titled: Invoice Creation or Final Invoice. In some embodiments, this screen is where users can select either line items from contract, or free form entry of line items, and apply various tax rates for certain items or for all items. In certain embodiments, the screen also provides an option to show non-charged items and also gives option to show the text for non-charged items, for example. FIGS. 20A and 20B illustrate an example of a screen shot of a page 200 titled: Project Time and Material Entry or Summary and Detail. FIG. 20A shows the top part of page 200 and FIG. 20B shows the bottom part of page 200. In a number of embodiments, this report is a collation between actual cost from an accounting application such as SOLOMON and estimated cost from the online management system. In certain embodiments, page 200 allows a user to easily compare actual and estimated costs.

The following is a list of potential users of certain embodiments of the invention and examples of modules that such users may have access to or may use. For instance, an Account Executive may use modules such as: Master Service Agreement, Review Estimate, Review Proposal, and Project Performance, for example. Further, an Account Management department employee may use all modules, for example. Further still, an employee of a Business Development department may use modules such as: Production Order, Time Tracker, and Requisitioning/Purchasing, for example. Even further, an employee of a CNC Router department may use modules such as: Production Order, Time Tracker, Requisitioning/Purchasing, and Project Closeout, for example. Further, an employee of a Design department may use modules such as: Design Request and Time Tracker, for example.

In addition, an employee of a Detailing department may use modules such as: Production Order, Time Tracker, Requisitioning/Purchasing, and Project Closeout, for example. Further, an employee of an Estimating department may use modules such as: Estimating, Change Order, Time Tracker, and Project Performance, for example. Further still, an employee of an Events department may use modules such as: Estimating, Change Order, Time Tracker, Requisitioning/Purchasing, and Project Performance, for example. Even further, an employee of a Finance department may use modules such as: Project Preliminary, Estimating, Time Tracker, Requisitioning/Purchasing, and Invoicing, for instance. Further, an employee of a Graphics department may use modules such as: Graphic Work Order, Production Order, Time Tracker, Requisitioning/Purchasing, and Project Closeout, for example. Furthermore, an employee of a Graphics Design department may use modules such as: Graphic Work Order, Production Order, Time Tracker, Requisitioning/Purchasing, and Project Closeout, for example.

Further, an employee of a I & D Labor department may use modules such as: Production Order, Time Tracker, Requisitioning/Purchasing, and Project Closeout, for example. Not only that, but an employee of a Metal Shop may use modules such as: Production Order, Time Tracker, Requisitioning/Purchasing, and Project Performance, for example. Further, an employee of a Paint Shop may use modules such as: Production Order, Time Tracker, Requisitioning/Purchasing, and Project Performance, for instance. Moreover, a project manager or an employee of a Project Management department may use modules such as: Production Order, Change Order, Time Tracker, Requisitioning/Purchasing and Project Performance, for example. What's more, an employee of a Purchasing department may use modules such as: Production Order, Time Tracker, Requisitioning/Purchasing, and Project Closeout, for example. Further, an employee of a Rental department may use modules such as: Production Order, Time Tracker, Requisitioning/Purchasing, and Project Performance, for example.

Additionally, an employee of a Show Services department may use modules such as: Production Order, Time Tracker, Requisitioning/Purchasing, and Project Performance, for example. Further, an employee of a Trade Show department may use modules such as: Production Order, Time Tracker, Requisitioning/Purchasing, and Project Performance, for example. And, an employee of a Traffic department may use modules such as: Production Order, Time Tracker, Requisitioning/Purchasing, and Project Performance, for example. Further, an employee of a Wood Shop department may use modules such as: Production Order, Time Tracker, Requisitioning/Purchasing, and Project Performance, for instance.

The Following is a list of possible job titles of users of an online management system in various embodiments of the invention. Specifically, users 19a, 19b, and 19c shown in FIG. 1, and other users mentioned herein, may include employees within departments or individuals with job titles such as: 3-D Design, Director Manufacturing, Intel Account Manager Account Executive, Director National Business Development, Intra Company Project Manager Account Manager, Director of Design, IT Administration Accounting Coordinator, Director of Financial Planning, Jr. Exhibit Designer Accounting Manager, Director of HR, Labor Supervisor Accounts Payable, Director of IT, Logistics Manager Accounts Payable Clerk, Director of Manufacturing, Mac Graphics Accounts Payable Manager, Director of New Account Development, Maintenance Accounts Receivable, and Director Project Management, as examples.

Further examples of potential users include: Marketing Coordinator Accounts Receivable Manager, Director Special Events, Marketing Director Admin/Receiving, Director, IT, Meeting Planner Administrative Assistant, Division Controller, National Accounts Manager Assistant Graphics Manager, Division Manager, National Dir/Prod-Events Assistant Project Manager, Division President, NE Division President Associate Producer, Estimator, New Orleans City Manager Building Maintenance, EVP Bus Process, Office Manager Carpenter, Executive Assistant, Operations Systems Specialist, Central Planning Manager, Exhibit Fabricator, Operation Director Chief Executive Officer, Fab/Shop Fmn, Operations Manager Chief Financial Officer, Fabrication, Orlando City Manager CNC Programmer, Facility Manager, Payroll/HR/Account COB, Field Service Supervisor, Portables Manager Consultant, Financial Administrator, Production Assistant Controller, Finishing Department Manager, Prod/Foreman Convention Services, Graphic Design, Product Manager/Estimator COO, Graphic Design Manager, Production Manager Corporate Controller, Graphic Designer, Project Administrator Corporate Director Event Services, Graphics, Project Manager Creative Director, and Graphics Manager.

Additional examples of potential users include:, Purchasing Creative Services, Graphics Production Manager, Purchasing Manager Customer Service, Graphics Production, Receptionist Customer Service Manager, Human Resources Administrator, Receptionist/Accounts Payable Design Assistant, Human Resources Coordinator, Receptionist/Payroll Design Manager, Human Resources/Receptionist, Regional Human Resources Manager Designer, I & D Field Sup, Rental Maint/Sup Detailer, I & D Supervisor, Rental Manager Director Convention Services, I&D, Rental Prop Sup Director Exhib I & D, I&D Checkout Manager, Sales, Sales AE in CA, Shop, Traffic/Whs Manager Sales Assistant, Shop Foreman, Transportation Sales Director, Shop Manager, Tvl Asso Controller Senior Account Manager, Shop Supervisor, Vice President New Business Senior Accountant, Show Services, Vice President Operations Senior Detailer, Show Svs Coordinator, Warehouse Senior Payroll Coordinator, Special Project Coordinator, Warehouse Manager Senior Team Leader, STL Collection Manager, Warehouse Production Senior Vice President—Events, Systems Administration, Warehouse Supervisor Senior Vice President of Marketing, Traffic Manager, Warehouse & Shipping Manager, and Wood Shop Supervisor, just to name a few.

The following identifies various hardware that is used with one example of an embodiment of the invention. Various embodiments of the invention may use other combinations of hardware, which may include some or all of the hardware listed, or other hardware. Thus, a particular example of an online management system uses ASP (Active Server Pages) and MICROSOFT SQL Technologies. Software is installed on a DUAL PENTIUM XEON 2.8 GHZ processor with 2 GB of Ram. Also used are (4) 400 GB Hard Disks, Ultra ATA/133 with Raid-5, a Tape backup, a Dedicated CISCO Firewall, an Installed SYMANTEC Software Firewall, a WINDOWS 2003 Server, an SQL Server License, Supporting Software, an Internet Connection, a Backup power supply, and a Round Robin setup with a secondary server having a different Internet and Hosting Provider.

Further, the following is an example of an embodiment of the invention that illustrates integration of an accounting application (e.g., SOLOMON) with a project management application (e.g., an online management system). Various embodiments of the invention may have different numbers of the following described features. Specifically, various embodiments of the invention include an accounting application such as SOLOMON PROJECT MAINTENANCE as well as an online management system that includes a Project Preliminary form or module. In this particular embodiment, every new or existing Job must have an allocated Job number. The Job number is allocated for a new or existing Job based on the details collated in the Project Preliminary form.

In some embodiments, there are certain necessary fields of information in the form, to complete a Project Preliminary request. Such necessary or required fields provide guidance to the users to enter necessary or desired information. These required fields in this embodiment are: Client Number (for new client a Dun and Bradstreet Business Report (D&B) must be approved in some embodiments), Description, Project Start Date, Project End Date (in some embodiments will be 30 days after End Show Date), Estimated Revenue, Account Executive, Project Name (in some embodiments this is the ID of the Project Manager), Allocation Method (defaulted to ALL2 for all jobs), Rate Table ID (defaulted to FROH for all jobs), GL Sub Account Type (divisional list, this will be a defaulted constant value), Contract Type (option to select FP, IC, INT, TM), Begin Show Date, End Show Date, Status (option to select), Billing Rule (options of BRO or IC), and Biller. These above fields of information would either be filled by the User or be defaulted to a constant value in different embodiments.

Various embodiments include a process of creating a Project Preliminary Form for a new project and get a job number. In some embodiments, a user enters the online management system and goes to the Project Preliminary form where the user enters details for the above fields of information, for example. On completion, in some embodiments, the user may save the details and select “Get Job Number”. In certain embodiments, this action will write the information into an accounting application such as SOLOMON and return back with a Job Number which will appear in the Job Number field of the online management system. In several embodiments, Project Preliminary forms can only be created for existing Client's or new Client's with the D&B check completed and approved.

In various embodiments, a user may complete a D&B check form which is available in an online management system under Project Preliminary. This form may be e-mailed, in some embodiments, to the Corporate Controller for audit once the form is completed. Once approved, the Client Name and Number will automatically be e-mailed to the creator, in particular embodiments, and may also be listed under the New Client section of the online management system, for example, within Project Preliminary, to select and proceed with the creation of a Project Preliminary form for a Job Number.

Various embodiments of the invention process Purchase Orders using an online management system, and specifically a module such as Requisitioning/Purchasing. In some embodiments, every Material or Service purchased is required to be supported by a Purchase Order to provide guidance to certain users. A Purchase Order is generated based on a material/service Requisitioning Request, in some embodiments, submitted through the online management system, specifically, through Material Requisitioning. There may be certain required information in the form, that is required to complete a Material/Service request. This required information may include, for example, a Job Name/Number, Date, Requested By, Approved By, Job Code, Task Code, Material/Service Description, Unit Cost, Quantity, Extended Cost, Vendor, Required Date, and Method of Payment.

In some embodiments, a particular process may be followed to create a Material/Service Requisitioning request and get a Purchase Order Number. In particular embodiments, the Creator of the Request will Enter an online management system Material Requisitioning request by selecting the (a) Job Number/Name (b) Enter Date (c) Approved By and (d) Requested By, field and select either Add Material or Add Service based on requirement. The creator may then, in some embodiments, fill in the above mentioned fields of information and on completion, click on Save & Send to Purchasing Agent. On finishing the above, in some embodiments, the Purchasing Agent of the division will get an e-mail notification of the request. In some embodiments, the Purchasing Agent, on entering the request, will be able to input (a) Actual Cost, (b) Promised Date, (c) Change Vendor if required and final, and (d) Get Purchase Order Number. Upon completion of a request, a purchasing agent may identify whether an Order was completed and click on an Update Solomon Button.

Certain principles may be followed for creating a Purchase Order for a Request. In some embodiments, Purchase Order numbers will be generated by the online management system. Therefore the purchasing agent will get the next sequential number for their request with a default prefix of the division number. For example a PO number may be 009123456. An existing online management system Material/Service Vendor Library may be updated to match the accounting application such as SOLOMON with respect to Name/Contact Information and Vendor Number, for example. In some embodiments, a user creating a Material/Service request can add a new material to the library which may require selecting a Vendor. If the vendor dose not exist, the User may be able to create a new Vendor on which the next sequential Vendor number will be allocated in some embodiments. In particular embodiments, the Purchasing Agent may be required to verify the Newly Added Vendor when they receive the request and select Create New Vendor in an online management system to update the An accounting application such as SOLOMON Vendor List. Once a request is processed by Purchasing Agent and finally uploaded to the accounting application such as SOLOMON, currently followed accounting procedures will follow.

Some embodiments include Customer Maintenance, a Customer List, or both. In certain embodiments, all new customers have to be requested to be entered into the accounting application or SOLOMON system by completing a “new customer request” form. On entering the customer information in the accounting application, the system may download the information to the online management system, for example. This function can be selected in the Project Preliminary module to create a new project and get a project number. Fields of information which may be transferred from the accounting application (such as SOLOMON) to the online management system may include: Client Name, Client Billing Data—Fax, Customer Number, Client Billing Data—E-mail, Client Billing Data—Company Name, Client Billing Data—Purchase Order Number, Client Billing Data—Client Contact, Account Executive, Client Billing Data—Street Address, Account Manager, Client Billing Data—City, State Zip, Project Manager, Client Billing Data—Telephone Number, and Datestamp Created, as examples.

In some embodiments, to provide guidance to users, some or all new Vendors may be required to be requested to be entered into the accounting application such as SOLOMON system. On entering the Vendor information in the accounting application, the information may be downloaded to the online management system. Once entered, in various embodiments, this information can be selected in the requisition/purchasing module to create a new purchase order. Fields of information which may be transferred from an accounting application such as SOLOMON to an online management system may include the following: Vendor ID, Class ID, Status, Vendor Name, Attention, Address Line 1, Address Line 2, City, State/Prov, Postal Code, Country/Region, Phone/Ext, Fax/Ext, E-mail Address, or a combination thereof.

An accounting application such as SOLOMON may facilitate Time and Expense Entry, which may interface with the online management system, and specifically, Time Tracker. In some embodiments, all time and stock material used may be entered into the time tracker module. Department managers may review the time card and on approval, in some embodiments, the information may upload to the accounting application such as SOLOMON. In particular embodiments, there are two modules in SOLOMON that it would upload to. These modules are Time and Expense Entry, for time charged to a job, and Journal Entry for debit/credit of stock material. In particular embodiments, fields of information which may be transferred from the accounting application to the online management system may include: TimeTrackerID, Date, EmployeeID, DepartmentID, JobID, JobCode, SHours, OHours, DHours, TaskCode, Notes, HourlyRate, BeforeLaborRateField, BeforeHREditLaborRate, usersession, ExportToSol, and LastExportToSol.

In some embodiments, an accounting application such as SOLOMON and an online management system each provide a Project Performance Report. Thus, in some embodiments, the project performance report would be available in both the accounting application and the online management system. In certain embodiments, the data for this report may be collated from both the accounting application and the online management system database and may provide estimated verses actual cost with payment terms and payment receivable on a project basis. In particular embodiments, fields of information to be exported from an online management system to an accounting application such as SOLOMON may include: “PROJ”, Project ID (Job Nbr), Total Internal Contract Value, Total External Contract Value, Total CO Estimated CM %, Total CO Estimated Hours, Total CO Cost, Total CO Contract Value, Per Contract 1, Per Contract 2, Per Contract 3, Per Contract 4, “TASK”, Task ID, Estimated Cost, Estimated Hours, and CO Cost, for example. Further, fields of information to be imported from an accounting application such as SOLOMON to an online management system may include: “PROJ”, Project ID (Job Nbr), “COST”, Task ID, Actual Cost, Actual Hours, “INVC”, Invoice Date, Invoice Nbr, Amt Invoiced, Invoice Due, and Amt Received, for example.

Certain embodiments of the invention include a concept that integrates two SQL databases over the internet. The concept involves transferring data for certain desired modules in a CSV (comma separated value) file and placing it on an intermediate server, such as intermediate server 16 shown in FIG. 1. In some embodiments, both the accounting application, such as SOLOMON, and an online management system are configured and have the ability to read or write specific data to the intermediate server and this server may be primarily treated as a common information depository system. In some embodiments, a stored procedure may read the data from the intermediate server and populate relevant modules, screens, or fields in the accounting application such as SOLOMON, for example. This stored procedure may then trigger the stored process to complete the transaction in some embodiments.

In particular embodiments, the method allows integration with no improper interaction with the accounting application or system. Further, in some embodiments, using the custom user setting of SOLOMON, modules or screens which are part of the integration are blocked for edit and are view only. This may streamline all data entry in an online management system and facilitate automatic upload to the accounting application.

The following describes a number of important features of certain embodiments of the invention, provided as examples. Various embodiments of the invention may have any number or combination of the features described herein. Some embodiments include a System Login Screen. In some embodiments, the User Name & Password is setup by system administration. Users are requested to periodically change their login credentials. But this may lead to in-consistency in following the approved policy. Some users change the login credential once and others are using the default. This reduces the security. Certain embodiments require users to change their Username and Password on their first time login, and periodically thereafter, such as every 30 days, for example. In some embodiments, this may provide an advantage of additional security and control in accessing rights for the system. Effected users may include, in some embodiments, all authorized system users.

Some embodiments include a Master Service Agreement (MSA) module. In some embodiments, AE (Account Executive) & AM (Account Manager) creates an MSA for new clients. A signed MSA eliminates the need for signing a SSA (Standard Service Agreement) for every approved contract. In certain embodiments, the current MSA has been replaced with a new revised MSA which conforms to policy and customer requirements. The module is programmed to be backward compatible. In some embodiments, this may provide an advantage of reducing customer concerns, reduce the need for editing, and speed up the client approval process. Effected users may include, in some embodiments, AE, AM, Finance, and Corporate personnel, for example.

Many embodiments include a Project Preliminary (PP) module, as described previously. In some embodiments, this may be the starting point of the online management system and may be created by either an AE or an AM. In some embodiments, to create a PP, the same information would be entered in both the online management system and the accounting application such as SOLOMON, a double entry process. The double entry may be needed in some embodiments to get a new project number, for example, from the accounting application. To eliminate double entry, improve accuracy of information in both systems and provide consistency in the inputted information, in certain embodiments he PP is linked with the accounting application (such as SOLOMON), for example, the Project Maintenance module. In some embodiments, data entered into the online management system may be batch processed and imported into the accounting application. In particular embodiments, the next sequential project number may be exported to the online management system. In various embodiments, default client billing data may be edited on a project to project basis. In some embodiments, this may provide an advantage of reducing project creation time, and also may send notification e-mails, and simplify the intra-division job sharing process. Effected users may include, in some embodiments, AE, AM, Finance, and Operations Directors (OD), for example.

Further, some embodiments include a Customer Library (F3). In some embodiments, the customer name is manually entered or selected from an existing customer library. Manual entry may reduce consistency and create errors on customer names and billing addresses, for example. In addition, customers may be entered multiple times in the library creating confusion and corresponding details may not match in the accounting application. To address this, in certain embodiments a customer library is linked to the accounting application, such as through the SOLOMON Customer Maintenance module, for example. In some embodiments, all new customers are created in the accounting application and transferred by batch process export to the online management system. This provides new customer based project creation control. In some embodiments, this may provide an advantage of eliminating certain manual entry processes. Corporate Finance may have more control of customer based project creation, in some embodiments. Effected users may include, in some embodiments, AE, AM, and Finance, for instance.

And some embodiments include a module called “Enter New Client Creation Request”. In some embodiments, a new client is manually entered in the PP form of an online management system and does not have any customer addition control check. A user usually sends an e-mail to a divisional controller to add a new customer in the accounting application such as SOLOMON. With the new Customer Library mentioned above, new customers may be created in the accounting application to make it available in the online management system, where a user can select and create a new project. In particular embodiments, this form facilitates the request being sent to the corporate controller and provides customer control checkpoints. In certain embodiments, the new client creation request form is located inside the PP module. In some embodiments, completion of the form sends a notification e-mail to the corporate controller and on addition of the customer in the accounting application, sends a return e-mail to the creator of the request. In some embodiments, this may provide an advantage of improved accuracy, greater consistency and also D&B check controls. Effected users may include, in some embodiments, AM, AE, and Finance, for example.

In addition, some embodiments include a Pre Design Estimating Worksheet. This worksheet may help designers with an actual design budget based on which a new design is to be created. In certain situations, a customer's budget needs to cover various aspects of the project, and this worksheet may help to provide a design budget. In certain embodiments, the worksheet is located inside the Design Request module. The worksheet may have a built in calculator and may calculate the Final Design Budget based on an Initial Client budget. In some embodiments, this may provide an advantage of reducing under-invented or over-budget invented projects. Further, in some embodiments, it reduces costs incurred in redesigning and re-estimating. Effected users may include, in some embodiments, a Designer, Estimator, Operation Director, AE, AM, and Sales Manager, for example.

Furthermore, some embodiments include a Production Order or Turnover meeting setup. In some embodiments, the AM may send e-mail or call project team members for the turnover meeting. But the e-mail is not always copied to all team members, and the time and date of the turnover meeting is not always communicated well. Inconsistency also exists in team members bringing project related information to the meeting. In certain embodiments fields for turnover date and time may be added in the production order form for project team members to review. In some embodiments, this may provide an advantage of Project team members being notified of the meeting time and date when the production order is released, thereby avoiding miscommunication. Effected users may include, in some embodiments, AM, AE, PM, Detailer, Shop Managers, Operation Directors, Shipping, and I&D, for example.

Moreover, some embodiments include a Regular Worksheet (Estimating). In some embodiments, for all general estimating purposes the Regular Worksheet is selected as the estimating template. If graphic work is to be estimated, a separate Graphic Worksheet may be selected. But in some such embodiments, this limits estimating to components which have graphics as part of the finished product. Also it requires additional line items and worksheets to be added within an estimate. In certain embodiments, the Graphics estimating section has been incorporated within the Regular Worksheet. In particular embodiments, the calculations and allocations for materials and labor cost may be recorded with the appropriate task codes. In some embodiments, this may provide an advantage that it may help reduce the need to use additional worksheets. Effected users may include, in some embodiments, Estimating, AM, and Operation Directors, for example.

Further, some embodiments include a Show Service worksheet In some embodiments, users select the Show Service Worksheet to estimate show service related work. Room for improvement may exist to simply the process of entering values in the worksheet and to capture additional cost centers. Certain embodiments provide simplified l&D Labor calculations, added further cost centers, or both. In some embodiments, this may provide an advantage of providing a faster and more consistent estimating process. Effected users may include, in some embodiments, Estimating, AM, and Operation Directors, for example

Further still, some embodiments include a Graphic Worksheet In some embodiments, an estimator completes the graphic estimating process based on his understanding of the task involved. Occasionally estimators may consult the graphic manager for added input in costing the graphic task. But some embodiments may have graphic department mangers actively estimate the graphic portion of the job to provide a more accurate estimate. This may also reduce estimators workload. In certain embodiments the Graphic Worksheet has been configured to work similar to the Transportation Worksheet. In some embodiments, an estimator may send certain requirements to the manager via e-mail, and on completion of the estimate, the graphics manager may e-mail back the worksheet. Finally, upon approval by the estimator, the worksheet may be automatically included in the job estimate, for example. In some embodiments, this may provide advantages of obtaining a better graphic estimate and reducing estimator workload. Effected users may include, in some embodiments, the Estimator, Graphics Department manager, Operation Director, and AM, for example.

Still further, some embodiments include a Project Performance Report. In some embodiments, a Summary and Detail report from an accounting application such as SOLOMON provides actual cost and a Production Cost Status report in an online management system provides estimated cost reports. In certain embodiments it may be beneficial to integrate the estimated and actual cost for a job into one report, including showing information such as billing amount and status. In particular embodiments, the report may have all current costs, eliminating the need for a secondary posting process. Current Job cost reports have been found to be important to monitor profitability of projects in some embodiments. Further, in certain embodiments, a new report is created in an online management system and an accounting application such as SOLOMON.

In particular embodiments, this report will be identical in content and will feed each other with the required information. For example: the report in the accounting application may export the actual values to the online management system and vice versa, the estimated values may be imported into the accounting application. In some embodiments, the reports may be updated every 3 to 4 hours, for example, and may show some or all recorded cost values. In some embodiments, this may provide an advantage of making available up-to-date accurate job costs. It may also, in particular embodiments, eliminate multiple report creation and manually collation. Effected users may include, in some embodiments, AM, PM, Shop Mangers, Operations Director, Estimator, Purchasing Agents, and Division Presidents, for instance.

Further, some embodiments include a module called Job Entries. In some embodiments, upon confirmed sale of a project, AM or Finance may select Job Entries, complete any missing project information, and change the status of the job from un-booked to booked. In certain embodiments, this is also done when the turnover meeting date and time is set up. In some embodiments, selecting the Save and Initiate button may send an e-mail notification to the project team. But the e-mail notification did not always have enough information, such as the date and time of the meeting, information regarding which project team members will be present, and the agenda for the meeting. In certain embodiments further fields of information may be added for setting up turnover date, time and location, for example. On saving and initiating the project, the notification e-mail may have additional content, in some embodiments, showing the information about the meeting. In some embodiments, this may provide an advantage of reminding users of the meeting and providing the agenda to be discussed, and therefore may provide a more efficient turnover. Effected users may include, in some embodiments, AE, AM, PM, Estimator, Detailer, Shop Managers, Shipping Managers and I & D Managers, for example.

As mentioned, some embodiments include a module called Time Tracker.

In some embodiments, time and stock materials used are entered in this module by salaried and hourly employees, for example. In some embodiments, the entered values are re-entered into the accounting application such as SOLOMON and ADP for Job cost reporting and payroll respectively. But some embodiments include features which may eliminate the double entry, increase accuracy, provide up-to-date job cost reporting, and simplify the data input process, for example.

In certain embodiments. the Time Tracker module provides an option to input time and material for multiple jobs in a single process form. This reduces screen refresh or save to database time. The new form also streamlines the data input process in some embodiments by reducing incomplete information entry. Further, in particular embodiments, the module is linked with the accounting application Time and Expense Entry and Journal Entry modules. In various embodiments, authorized users, after verifying the correctness of the inputted data, may select Save and Upload SOLOMON, for example, which is configured to import into SOLOMON. Reporting based on department, job, show and date range are also options of the module in various embodiments. In some embodiments, this may provide an advantage of eliminating double entry and possible reduction in input errors, instant reporting and better job cost control. Effected users may include, in some embodiments, Shop Managers, Shipping Managers, Estimators, PM, Detailer, CNC, and Design staff, for example.

Further, some embodiments include a module called Requisitioning/Purchasing. In some of these embodiments, a request is credited and sent to a purchasing agent who may then enter the request in an accounting application such as SOLOMON to create a purchase order number. The details from the accounting application may then be manually updated in an online management system, in certain embodiments. In many cases the PO is directly created in the accounting application. To eliminate the double entry, some embodiments include a function that creates a process for requesting a material or service, and ordering and receiving ordered materials. Included in particular embodiments is an automated notification process for project team members of the purchasing status. In various embodiments, this function may also update job cost reports for incurred material and service costs.

In certain embodiments, an online management system module is integrated with the accounting application Purchasing module. All purchasing done in the online management system may be batch process exported to the accounting application such as SOLOMON, in some embodiments. In particular embodiments, project related or non-project related purchases may be done in the online management system. Further, in some embodiments, PO's edited in the accounting application may be batch process exported to the online management system. Reporting, searching by purchase order number, requisition number, identification number, Vendor, Buyer Name, Back Order, Open Orders, Summary Reporting, Change History, and Requisitioning reporting are all functions that may be available in various embodiments of the module. In some embodiments, various such functions may provide an advantages of eliminating double entry and possible reduction in input errors; instating a requesting and PO creating process, and providing nearly instant reporting and better job cost control. Effected users may include, in some embodiments, Purchasing Agents, PM, AM, Detailer, Shop Managers, and Shipping Managers, for instance.

Further, some embodiments include a module called Project Close Out. In some embodiments, various concerns and suggestions are recorded in this module for later reference. But in some circumstances, project team members have not been notified of the data being inputted and have failed to review the data. To address this, certain embodiments provide for sending an e-mail to Project Team members when data is inputted in the module. In some embodiments, this may provide the advantage that Users would be made aware of the information and not miss reviewing the details. Effected users may include, in some embodiments, Shop Managers, PM, Detailer, Purchasing Agent, AM, AE, Operation Director, and Shipping Managers, for example.

What's more, some embodiments include a module called Graphic Work Order In some embodiments, a work order is created detailing the specifications of the task to be completed. The work order is sent to graphic production departments of divisions, in some embodiments, based on which location is scheduled to produce it. Various embodiments may simplify the work order creating process and rectify computer operating system compatibility issues. For instance, certain embodiments have all functions work on WINDOWS and Mac's. In some embodiments, most or all unused functions and options may be removed. In some embodiments, this may provide an advantage of providing simpler and wider range system operations. Effected users may include, in some embodiments, Graphic designers, Graphic production managers and PM, for example.

The following lists certain modules of some embodiments of the invention which may provide important improvements over the prior art in certain applications. Various embodiments of the invention may contain a number of these modules. Information regarding the modules is also provided that relates to particular examples of embodiments of the invention. One such module is the Project Preliminary module. In some embodiments, this is the Starting Point of the online management system. Information related to the project is entered into this module and upon submission, data is uploaded into an accounting application such as SOLOMON, which may write back the next sequential Job number. In many embodiments, unless a Project Preliminary is created, various functions or all other modules cannot be used. Thus the system only recognizes a project which exists in the Project Preliminary, in some embodiments.

Also included in this module, in many embodiments, is a New Customer Request form. Particulars of a prospective customer may be entered in this New Customer Request form, in particular embodiments, and send to accounting for review. On approval, the new customer may be created in the accounting application and automatically downloaded to the online management system in some embodiments where a user can select and open a new project . In some embodiments, this may provide an advantage of providing a single common project information entry point. In various embodiments, it may also eliminate double entry, provide guidance and controls to monitor new project creation, and provide notification to divisional managers of possible upcoming intra-company projects, for example.

Further, in many embodiments, this Project Preliminary module is the main structure module of the online management system. Information inputted into this module may be filtered to most or all other modules of the online management system in various embodiments. New project creation controls, notifications of outstanding balances for existing clients, and initiation of an intra-company project are all linked to this module in particular embodiments. In certain embodiments that use SOLOMON, the Project Preliminary Module interacts with the Project Maintenance Module (PA.PRJ.00), Customer Maintenance Module (08.260.00), and Employee Maintenance Module (PA.EMP.00), for example. Effected users may include, in some embodiments, AE, AM, Finance, and Operations Directors (OD), for instance.

Another important module in many embodiments is the Estimating Module. In some embodiments, the Estimating module is a combination of three sub modules: Estimating, Review Estimate, and Review Proposal. Estimating is considered the Backbone of certain embodiments of an online management system. In particular embodiments, this module provides processes, templates to input information towards getting a Sell Price, Cost, Time, Material, Purchasing, and reporting, for example. In various embodiments, the estimating module is where line item descriptions are entered and worksheets are assigned. The line item can be estimated using materials from the library, for example, such as materials library 27 shown in FIG. 2. In some embodiments, as the estimate progresses the Total Price, Total Cost, and Contribution Margin are calculated. Estimating intra-company, locking and approving an estimate, and assigning components of an estimate, either estimated or produced by an Intra-Company, are all functions of various embodiments of the estimating module.

In various embodiments, the Review Estimate module is a replica of the Estimating module with only a review option. Data for the worksheets or line items cannot be changed in particular embodiments of this module. In some embodiments, this may provide an advantage of providing similar estimating process for all divisions and for all estimators. Certain embodiments line itemize each component of the project, reducing miscommunication and enhancing description and scope of work, for example. Some embodiments simplify estimating processes, provide estimated cost reports, and provide estimated contribution margins, for instance. In various embodiments, approval processes maintain integrity of the content, and approved estimates may be converted to a proposal, eliminating double entry. In some embodiments, the Estimating module has a relationship with Requisitioning/Purchasing, Production Order, Change Order, Project Performance, Invoicing, and Job Entries of the online management system. In particular embodiments that utilize SOLOMON, the Estimating module interacts with Project Performance Report (XR.PPF.00), for example. Effected users may include, in some embodiments, Estimating, AM, and Operation Directors, for example.

Another important module in many embodiments is the Proposals/Contracts module. The process performed by this module, in many embodiments, is to convert the estimated description to a proposal/contract. This may help maintain the integrity of the scope of work estimated and any special specification considerations, for instance. Only an approved estimate may be converted into a proposal, in many embodiments, and approval is done by either the operations director or division president, for example. In some embodiments, a Sub Total option may be selected to rearrange line items, apply taxes, add opening and closing statements, or attach a contract, agreement, payment terms, timeline, graphic production guidelines, or credit card authorization form, as examples. Customers who have not signed a MSA would have a SSA attached to the proposal when submitted, in a number of embodiments. In some embodiments, this may provide advantages of eliminating double entry, maintaining integrity of the scope of work, or both, for example. This module may interact with, within the online management system, other modules such as Estimating, Invoicing, and Review Estimate, for example. For embodiments having an accounting application such as SOLOMON, this module may interact with the Project Performance Report (XR.PPF.00), for instance. Effected users may include, in some embodiments, Estimating, AM, PM, and Operation Directors, for example.

Another important module in many embodiments is the Time Tracker module. In various embodiments, this module may record some or all Labor hours and Stock Materials used for a project, for example. In certain embodiments, most or all hourly and salary employees are required to enter time spent on each individual project every day, for instance. In some embodiments, production may also enter stock materials used. In particular embodiments, the labor and material cost may be computed for the Project Performance Report. Also, based on hours worked per week, production forecasts may be altered for the following week in some embodiments. Further, the cost for labor and materials is set up in the divisional settings module in certain embodiments. In many embodiments, the approved data may be uploaded to an accounting application such as SOLOMON. In some embodiments, this may provide an advantage of eliminating double entry, and approved entries can be automatically uploaded to the accounting application. Also, in various embodiments, the Time Tracker module, provides an up-to-date job cost report. Further, in some embodiments this module may track Stock Materials usage and maintain Stock material inventory, for example. Within the online management system, the Time Tracker module may interact with the Project Performance Report, for instance. For embodiments utilizing SOLOMON the Time Tracker module may interface with the Time and Expense Entry Module, the Journal Entry Module, the Project Performance Report (XR.PPF.00), or a combination thereof, for example. Effected users may include, in some embodiments, Shop Managers, Shipping Managers, Estimators, PM, Detailer, CNC, and Design personnel, for example.

Another important module in many embodiments is the Requisitioning/Purchasing module. In various embodiments, this module is used to generate a purchasing request, which is then sent to a purchasing agent, for example. The purchasing agent may convert the request into a purchase order in some embodiments. Some or all purchases for a project may be required to be done through this module in certain embodiments. By submitting a requisition, an e-mail may be sent automatically to the PM, Detailer, and Purchasing Agent (PA), for instance. In some embodiments, the PA can convert the received request to a Purchase Order (PO). A completed PO may be uploaded to an accounting application such as SOLOMON in many embodiments. The PM and PA can track the purchasing process of ordering, including receiving, back order, return items, and open orders, for example, in a number of embodiments. Further, in some embodiments, the PA can process project related or non-project related PO's. Further, PA can select materials from a built in material library in certain embodiments. This process may provide monthly, quarterly or yearly material usage reports, or a combination thereof, which may help in national purchasing in various embodiments. Other reports available in the module in particular embodiments may be based on purchase order number, requisition, identification number, Vendor Name, Buyer name, Project Purchase Summary, Requisitioning Summary, or a combination thereof for example. In some embodiments, the Requisitioning/Purchasing module may provide advantages of eliminating double entry, providing a single purchasing process for all divisions, providing a requisition creating process, providing material usage reports, providing job cost reports, and providing purchase progress monitoring, as examples. The online management system may interact through the Project Performance Report, Estimating, or both, for example. Additionally, embodiments using SOLOMON may interact with the Purchasing Module, Vendor Maintenance, Project Performance Report (XR.PPF.00), or a combination thereof, for instance. Effected users may include, in some embodiments, Purchasing Agents, PM, AM, Detailer, Shop Managers, and Shipping Managers, for example.

The following lists certain functions of some embodiments of the invention which may be important improvements over the prior art in certain applications. Specifically, various embodiments of the invention may contain any number of these modules or functions. in particular, a project preliminary module may provide new project creation and new customer addition. And a time tracker module may provide multiple entries, a single process screen, and a stock material library. Further requisitioning/purchasing may generate requests, convert them to POs, and provide a vendor library. And a reporting module may provide integrating of estimated cost and actual cost.

Next, the following lists certain departments of an organization or company that may use one or more of various computer implemented systems or methods of the invention. In particular embodiments, use of such systems or methods by these departments may be important improvements over the prior art, for example, in certain businesses or applications. Information regarding how the departments use these embodiments is also provided that relates to particular examples of the invention. Various embodiments of the invention may use the invention in any number of the ways described herein.

An example is a department called Estimating, which may have a reporting relationship with the Account Executive, Division President, or both. In some embodiments, the Estimating Department is responsible for utilizing the Estimating module described herein to create some or all project estimates, for example. This may include timely and accurate preparation of cost/pricing estimates for some or all projects requested by Account Executives and/or Account Managers as described with reference to the Design Request module, for instance. In many embodiments, estimates may take into consideration perceived shop capacities by reviewing the Production Forecast reports, for example. In certain embodiments, an Estimator may review the Project Performance Report for up-to-date cost data before proceeding with the estimate. In particular embodiments, the department may create weekly audit/variance reports as required using data from the Project Performance Report. In some embodiments, the department may be required to maintain a 45% CM margin on all estimates. Estimating may include, in some embodiments, using available worksheets and breaking down components to materials and labor. The department may be responsible for maintaining system policies and procedures for data maintenance and system security in some embodiments. System utilization by this department may include, in particular embodiments, Estimating, Material Editor, User Editor, Standard Components Editor, and Change Order Department, for example.

Another example of a department is an Account Management department, which may have a reporting relationship with an Account Executive, Division President, or both, for example. In some embodiments, the Account Management Department may be responsible for creating new projects by completing the Project Preliminary form, for example. In addition, the Account Management Department may be responsible for requesting addition of new clients, in some embodiments, by completing the New Client Request Form and submitting it to the corporate controller.

The Account Management Department may also be responsible for articulating design requirements for the design department describing the client requirement by using the Design Request module, and articulating the scope of work in the Estimate description, for instance. In various embodiments, creating production orders, labor orders, booking jobs, purchasing show services, invoicing completed jobs, or a combination thereof may be responsibilities of an Account Manger. In some embodiments Account Mangers may be a conduit for information flow between AE/Client and Production. System utilization by the Account Management department may include the Master Service Agreement, Project Preliminary, Estimating, Review Estimate, Review Proposal, Production Order, Change Order, Shipping Receiving Order, Labor Order, Job Entries, Requisitioning/Purchasing, Invoicing, or a combination thereof, for example.

Another example of a department is Project Management, which may have a relationship with the Director of Project Management, the Director of Operations, or both, for example. In some embodiments, Project Management is responsible for Reviewing the details of Production Orders, checking the details on the review estimate, and providing detailed information to production, for instance. Project Management may also be responsible at project close out, in some embodiments, to record issues, and suggestions regarding the project. Project Management may also be responsible for recording additional work which is beyond the scope of the approved contract (change order work), and for generating material requisitioning to order materials for the job and tracking the purchasing process for a timely delivery to the shop, in certain embodiments. Project Management may also be responsible, in particular embodiments, for recording the time spent on projects through time tracker and reviewing the project performance report to maintain the estimated CM%. System utilization of this department may include Review Estimate, Time Tracker, Requisitioning/Purchasing, Production Order, Change Order, Project Close Out, Project Performance, or a combination thereof, for example.

Another example is a Purchasing Agent department, which may have a relationship with a Director of Operations. This department may be responsible, in some embodiments, for purchasing goods and services in a timely and cost-effective manner, and to ensure that purchase orders and receiving reports are forwarded to Accounts Payable. System utilization of this department may include Requisitioning/Purchasing, Project Performance, Project Close Out, Time Tracker, or a combination thereof, for example.

Yet another example is a Controller department, which may include a Division President. In some embodiments, system utilization for this department, in some embodiments, may include Project Preliminary, Review Proposal, Change Order, Invoicing, Project Performance, or a combination thereof, for example.

The following is an example of an embodiment of the invention that includes an integration process between an online management system and an accounting application. Various embodiments of the invention may contain any number of the details and features described herein. In some embodiments, a link may exist between an online management system, or specifically the Project Preliminary module and an accounting application such as SOLOMON, or specifically, the Project Maintenance module, as examples. In particular embodiments, the Client fields in the online management system, Project Preliminary, has an F3 function (button) similar to the F3 function in an accounting application such as SOLOMON, for example. In some embodiments, the new F3 window may show all existing clients available on the accounting application. A User may select an existing client name or customer number and may have the option to search for either in certain embodiments. Next, the user may enter all required fields of information in Project Preliminary, for instance. Then the user may Select a “Submit-Get Job Number” button in some embodiments. This will send the required information to the accounting application database in particular embodiments and the accounting application may write back the next sequential job number into the online management system. In some embodiments, users may be prompted with a pop up message, before transmitting the information and getting a job number. In some embodiments, the information may include the division the new Job belongs to, the first three characters of the Job number (example: 007 or 009), or both, for example.

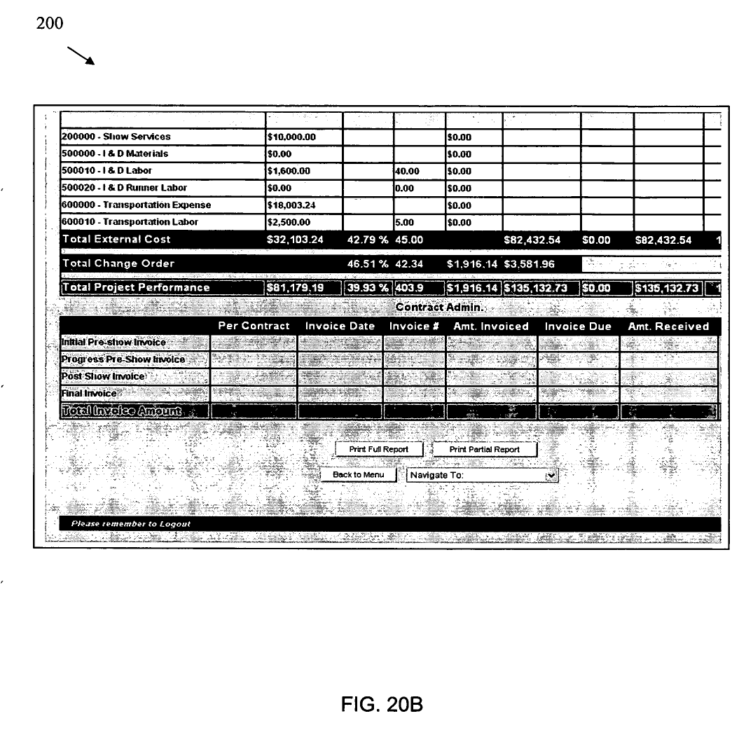

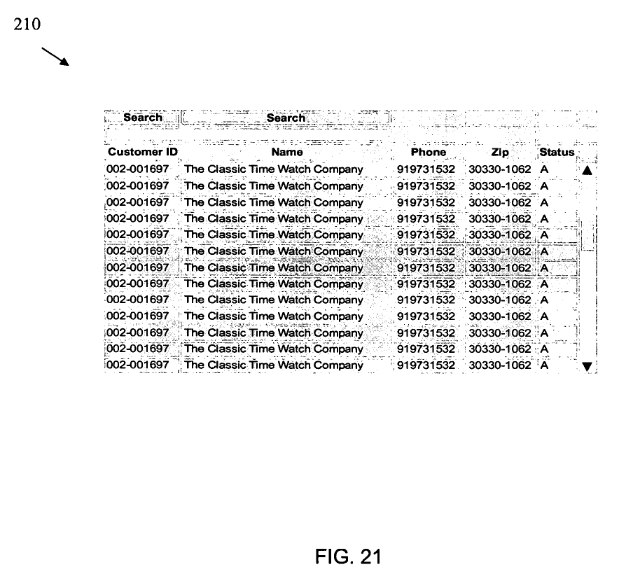

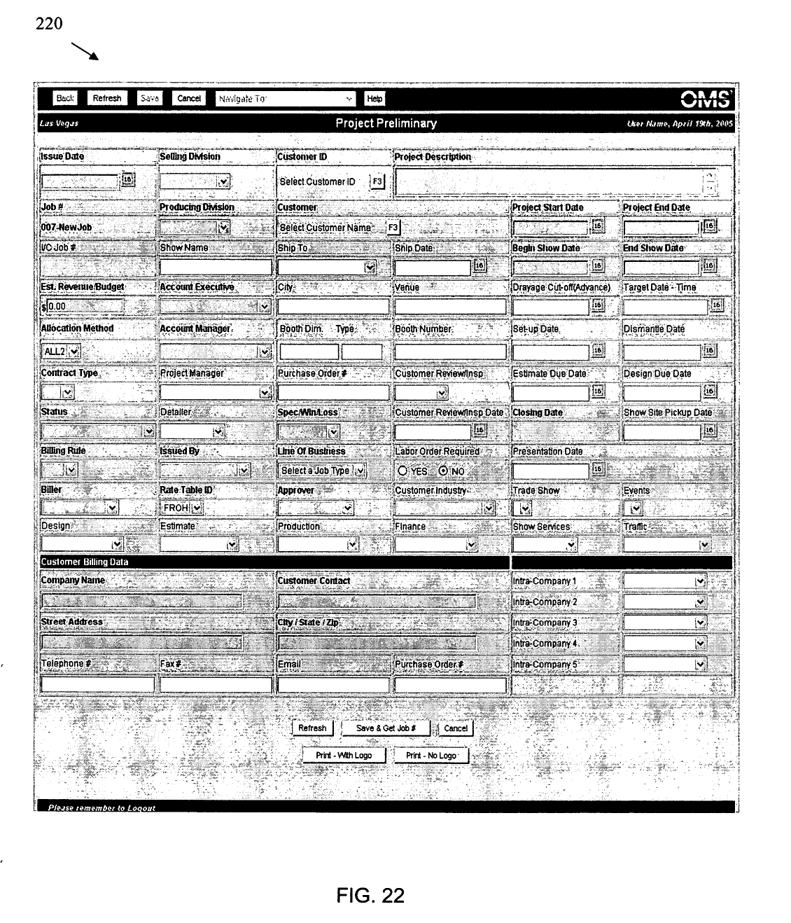

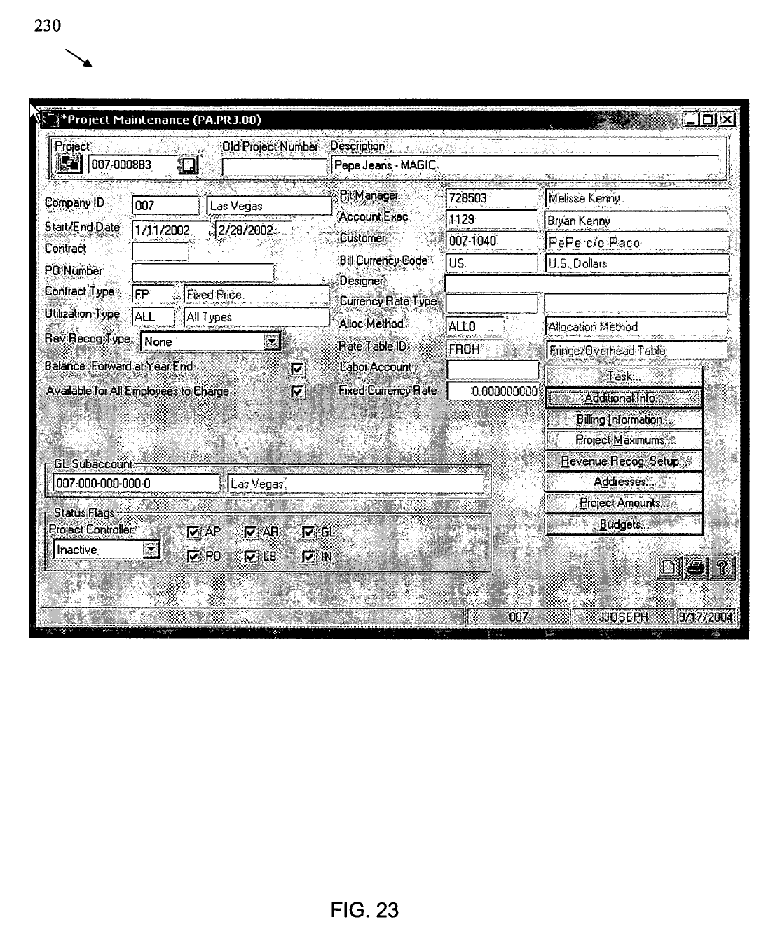

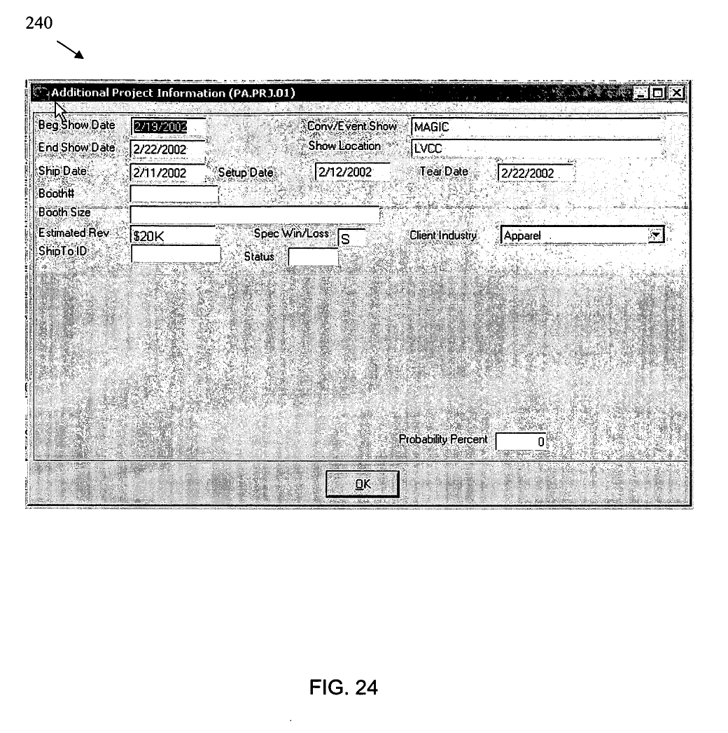

FIG. 21 illustrates an example of an F3 Screen 210 of an example of an embodiment of an online management system. This screen may appear with the latest data from the accounting application. For example, if a New Client is added, this list would be updated in particular embodiments. In addition, FIG. 22 illustrates an example of a screen shot of the project preliminary module, page 220. FIG. 22 shows, among other things, the data required in the fields of a particular embodiment of the invention. Furthermore, FIG. 23 illustrates a screen 230 of an accounting application, specifically, SOLOMON PROJECT MAINTENANCE. Screen 230 may illustrate a first screen of the accounting application, for example. Moreover, FIG. 24 illustrates another screen shot 240 into which additional project information may be entered or displayed in some embodiments. Even further, FIG. 25 illustrates another screen 250 of the accounting application, specifically, SOLOMON PROJECT MAINTENANCE. Screen 250 may illustrate a second screen of the accounting application, for example.

Certain functions or tasks will now be described that may be undertaken in one example of an embodiment of the invention. In this particular embodiment, the online management system presents an F3 Screen to display Customer ID, Name, Phone, Zip, and Status. In this embodiment, on top of the first two fields is a search text box for the user to input a value and perform a search. On selection of an existing client, the following fields may be auto populated in the Project Preliminary: Client Name, Customer Number, Client Billing Data, AE name, AM name, and PM name. The online management system may then check for any new client being created in the SOLOMON database. If a new client is found, then the system will populate the F3 Screen and its related tables with information. The online management system may then display in a pop up Screen the division the Jobs belongs to, and the first characters of the new created Job number for the user to verify and accept, before transmitting the details to SOLOMON. SOLOMON may then accept the new client information from the online management system and trigger the next sequential job number in SOLOMON. These are the required fields in this particular embodiment of the online management system and SOLOMON.

Information that may be transferred between an accounting application such as SOLOMON (Project Maintenance module) and an online management system (Project Preliminary module) may include: Customer Number, Description, Client Project Start date, Project Start date, Project End date, Estimated revenue, Account Executive, Project name, (ID of the Project Manager may be used), Project Manager, Allocation Method (which may be defaulted to ALL2 for all jobs in some embodiments), Rate table ID (which may be defaulted to FROH for all jobs in some embodiments), GL Sub Account (divisional list, defaulted constant value), Contract Type (option to select Contract Type, FP, IC, INT, TM), Begin Show Date, End Show Date, Status (option to select), Status Billing Rule (option to select BRO, IC), Billing Rule, and Biller (option to select), as examples. In some embodiments the accounting application, for example SOLOMON, may store newly entered client information for the online management system to extract from.

Another task or function, in this particular embodiment, is requesting for creation of a new client and assigning a customer number after completion of a D&B check. In this embodiment, the user may be required to send a request for creating a new client to a division controller, and the controller may conduct the D&B check if required, create the new client, and assign a customer number in the Customer Maintenance module of the accounting application (SOLOMON). This may be done manually in some embodiments. In this particular embodiment, the Controller may send back the newly created Client name and Customer number to the user for creating a new Project Preliminary form and assigning a new Job number.

In the online management system, in this embodiment, the user may Create a “New Client Creation Request” form, and insert the button in the first Project Preliminary page. In particular embodiments, the form will have the following fields of information; Create check box in User Editor module to define who should receive e-mail notification when a New Client Creation Request is sent; Provide a check box option to allow users to see the new button in PP; and Provide a Log Viewer to track the creation of the request and return e-mail from the controller. Fields of information in the form may include, in certain embodiments, Created By, Created Date, Client Number, Client Name, Client Contact A, Client Contact B, Company Name, Street Address, City/State/Zip, Phone Number, Fax Number, E-mail Address, Account Executive, Account Manager, Project Manager, Project Type, Estimated Revenue, and Notes.

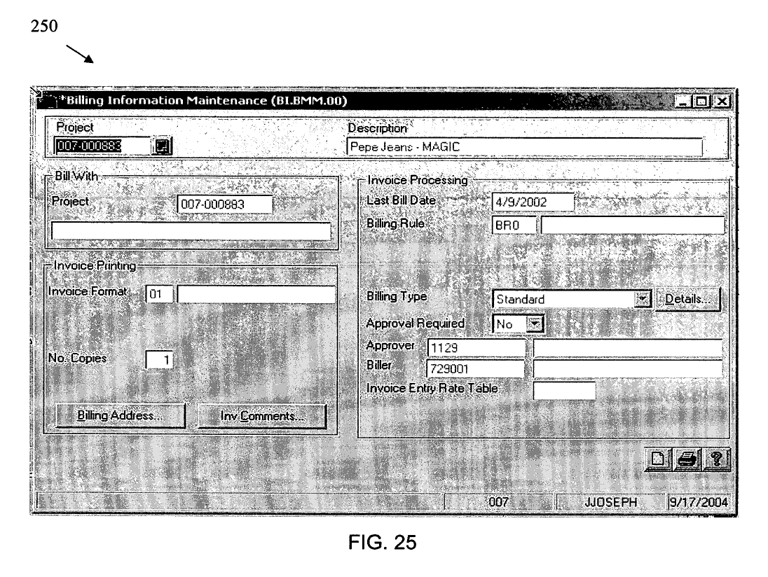

FIG. 26 illustrates an example of a screen shot, screen shot 260, of the page Add New Client Creation Request. Data to be collected in indicated on Revenue in some embodiments. screen shot 260. Note that the field Client Tax ID may be changed to Estimated

Next will be described details of a link between the online management system, specifically the Material Requisitioning module, and the accounting application (SOLOMON), specifically the Purchase Orders module, in particular embodiments of the invention. Specifically, in this embodiment, users may be able to create a purchase request in the online management system through a Material Requisition module and select a “Save and Send to Purchase Agent” button. The Purchasing agent may review and edit the request, and if needed, input correct and updated information to complete the remaining fields, and then select the “Get PO Number” button in this embodiment. Finally, the purchasing agent may be required to select “Save and Submit” to upload the details into the accounting application such as SOLOMON.

In this particular embodiment, general users do not have rights to edit the material library or its associated price but can add a new material. In some embodiments, general users may not be given rights to edit a submitted request. In this embodiment, a purchasing agent may have full edit rights even to edit a material description and its price. Upon selecting “Save and Submit”, the material library of an online management system may be updated with any changes to material specifications. A Vendor may have one material or many materials. Further, in this embodiment, a Purchasing agent may be able to get the next sequential number without a request and may later use that number to enter the request. Therefore, the PA may be able to save a request without any data if needed. In addition, a PA may be able to delete a request line item or add new line items, as needed.

In this embodiment, existing vendor names may be matched with the accounting application Vendor names and the accounting application Vendor ID numbers may be assigned to the online management system Vendors. Not only that, but an online management system may be configured to have corresponding fields to those of the accounting application, such as SOLOMON. In certain embodiments, Shipping and Receiving may have editing rights to the “Received By” and “Received” button. In this embodiment, an online management system may record initials and date of the user who has changed details for a purchase order. In most cases, the ship to address is the division address, but the shipping address could be different and there may be an option to change that address in certain embodiments. A new Purchase Order form may be created in this embodiment, which may be similar to an accounting application such as SOLOMON.

Programming to accomplish this task may include, in some embodiments, the online management system matching up Vendor Names from the accounting application (e.g., SOLOMON) and the online management system databases. It may also be necessary or desirable to assign existing Vendor ID numbers to online management system vendors to match the accounting application. Fields to match and create may include: Vendor ID (create), Vendor Name, Phone, and Zip. In certain embodiments, the online management system may also modify an existing Material Requisition form to have additional fields. These may have drop down options to select, for example. It may also create an editor interface to add or delete certain fields. These fields may include, for example, Method of Payment, Purchase For, Account, Task, Sub Account, and PO Type.

In some embodiments, the online management system may include accessibility logic to have different permissions set for a General User, a Purchase Agent, and for Shipping and Receiving, for example. These may be entered through user editor check boxes in some embodiments. In certain embodiments, General Users can only select an existing material or add a new material to the library, while Purchasing Agents can edit a material description or its associated price or change the vendor. In some embodiments, a PA can also add new request lines or delete an existing line. A PA can also get a PO number with out any details in the request line in some embodiments. Further, Shipping and Receiving may only be able to edit Received By and Received fields in certain embodiments.

In various embodiments, the online management system may include buttons to “Save and Submit” and “Get PO #. Save and Submit may be used to collate all required information and create CSV output to send to the accounting application (e.g., SOLOMON) Database. Further, Get PO# may be used to get the next sequential PO number. In some embodiments, the online management system may also record initials and date of the person who changed an existing purchase order. These details will only show up in an online management system collation report in some embodiments. The initials may be based on the login information of the user, for example.

In particular embodiments the online management system may include a function called Ship To field. In some embodiments, by default this field may have division address, but by selecting the “Other” option, a user may be able to create a new address to ship to. This field may be found on the Purchase Order form. In certain embodiments, fields required to create a new ship to address include: Name, Attention, Address1, Address2, City, Sate/Prov., Postal Code, Country/region, Phone, Fax, and E-mail Address, for example.

In some embodiments, the online management system may include a purchase order print form. Further, the accounting application, such as SOLOMON, may be programmed in some embodiments to accept incoming CSV data for requisitioning and populate required tables. The accounting application may also be programmed in some embodiments to record a new field (Req. #). This may be a unique number associated with each request line item. The accounting application may also check if Req. # is similar in both databases. If not, then the accounting application may either transfer information to the online management system or vice versa. This may be desirable because if users create a Purchase Order in the accounting application, it would be helpful to transfer that information to the online management system and vice versa.

Fields are listed below that may be required to be transferred to the accounting application in a particular embodiment of the invention that is described to serve as an example. Various embodiments may offer or require any number of these fields or different fields. These fields include: Client Name (user select), Show (auto populate), Project Manager (auto populate), PO Number, (next sequential, auto populate), PO Type (auto populate to Regular Order), Vendor (auto populate), Vendor ID (auto populate), Today's Date (auto populate/user select), Approved by (user select), Job Number (auto populate), Method of Payment (user select), Purchase for (user select), Item Number (auto populate), Material (user select), Job Code (user select), Qty (User Select), Unit (User Select), Unit Cost (User Select), Extend Cost (auto populate), Shipping Cost (user select), Date Required (user select), Budget (user select), Promised (user select), Account (User select), Project (user select), Task (user select), Sub account (user select), Quote available (user select), Received by (user select), Return Item Cost (user select), Back Order (user select), Ordered (user select), Received (user select), Ship to (user select), Requested by (user select), and Notes (user select).

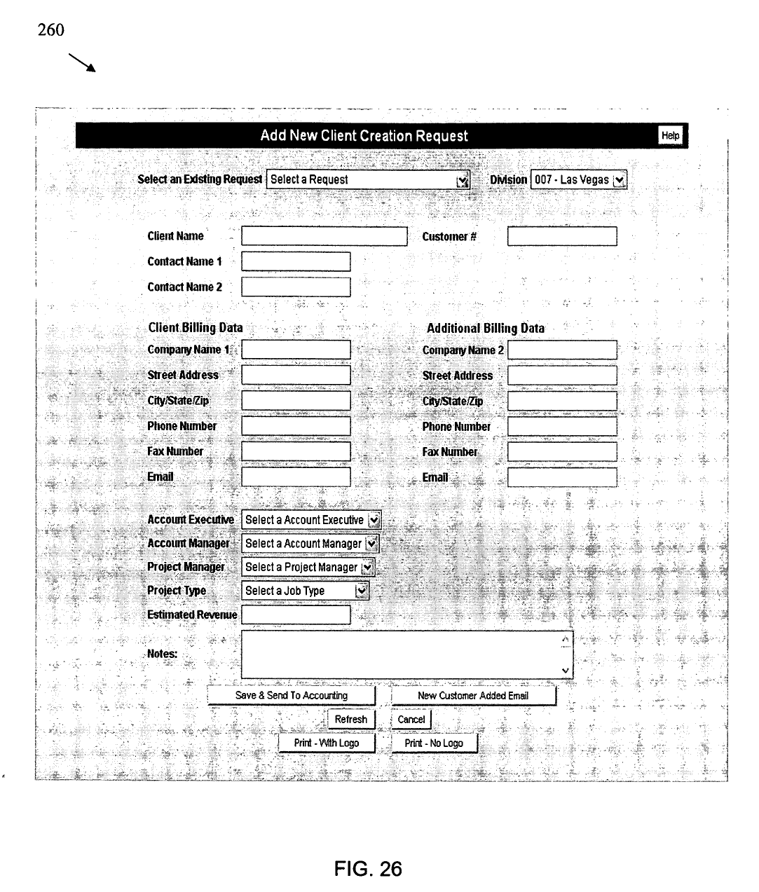

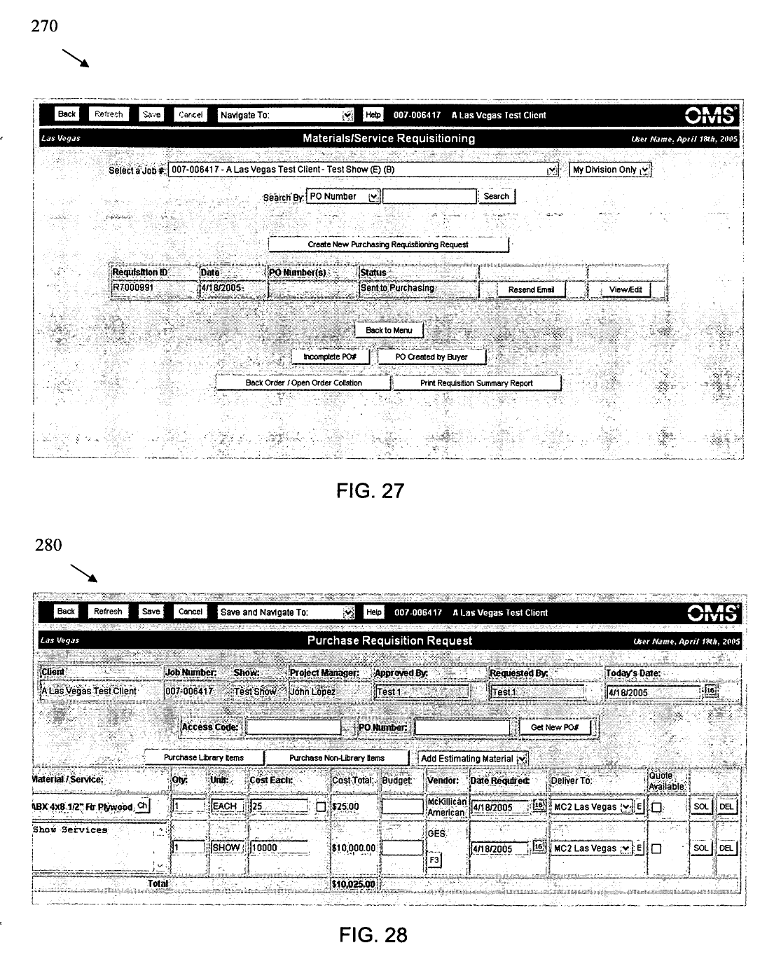

FIG. 27 illustrates an example of a screen shot, screen shot 270, of the page Material Service Requisitioning. Further, FIG. 28 illustrates an example of a screen shot, screen shot 280, of the page Purchase Requisition Request. These screen shots illustrate, among other things, examples of information that may be displayed or input in particular embodiments of the invention.

As mentioned, embodiments of the invention may contain various combinations of the modules, features, functions, and components described herein. Various embodiments of the invention may perform steps or functions electronically, in real time, or both. As an example, a particular embodiment of the invention is a computer-implemented management system that includes a management application and an accounting application. Another example of the invention is a management application that includes certain modules, features, functions, or components described herein. Another example is an Internet-based management system that includes certain applications, modules, features, functions, or components described herein, which may include, for example, a management application, an accounting application, or both.

In some embodiments, the management application may further include an estimating module, a project performance report module, and a time tracker module, for example. In some embodiments, the management application includes a project preliminary module. In some embodiments, the management application includes a proposals/contracts module. In some embodiments, the management application includes a requisitioning/purchasing module. Some embodiments of the invention include modules of one or more particular categories. For instance, in some embodiments, the management application includes project proceeds modules. These project proceeds modules may include at least one of a master service agreement module, a project preliminary module, a design request module, an estimating module, a production order module, a change order module, a graphic work order module, and a shipping and receiving module, for example. In some embodiments, the management application includes at least one show services module, which may include a labor order module, for example.

In some embodiments, the management application includes various report modules, which may include, for instance, at least one of a project performance module, a production forecast module, a project list module, a time card module, a project lifeline module, and an open jobs module. In some embodiments, the management application includes certain production management modules, which may include, for instance, at least one of a job entries module, a time tracker module, a Requesting/Purchasing module, and a project closeout module, for instance. In some embodiments, the invention includes at least one accounting module, which may include, for example, an invoicing module.

In some embodiments, the management application includes various miscellaneous modules, which may include, for instance, at least one of an online help module, a user editor module, a material editor module, a vendor editor module, a standard component editor module, a carriers editor module and an edit username/password module, for example. In certain embodiments, the management application may be network based, or Internet based, for example. And in certain embodiments, the management application and accounting application may use SQL databases. In certain embodiments, the management application and accounting application may use DTS programming, and may be configured to automatically transfer data between the management application and the accounting application. In certain embodiments, the management application may contain pages that require the entry of certain information, and at least some users may be required to input the required information before proceeding, for example, to a different page, to create a job number, or the like. In certain embodiments, access for some users may be limited or some users may have access to read certain information but not edit it, or both.

Certain embodiments of the invention include integrating at least two SQL databases over the Internet. Data may be transferred in a SCV file and placed on an intermediate server. A plurality of applications may be configured to read from, write to, or both, from or to the intermediate server, and may be configured to populate relevant fields in at least one application with information obtained from the intermediate server, which may involve using data entered in another application. These applications may include, for example, the management application or accounting application described herein, or both. The intermediate server may be configured to be a common information depository system. In certain embodiments, the management application may be hosted on a management server, the accounting application may be hosted on an accounting server, and the management server and accounting server may be linked, for example, via a network, such as the internet, to an intermediate server.

In particular embodiments, the invention may include a management server, an accounting server, and an intermediate server. Various embodiments of the invention are methods, such as methods of managing business activities, which may be electronically or computer implemented in whole or in part. Various methods or steps may provide information to certain users or in certain arrangements (such as in tables, reports, electronic pages, spreadsheets, or web pages, for example) in real time or substantially in real time. Such methods may include, for example, the steps of creating a job in a management application, entering data relevant to that job in the management application, sending at least some of the data from the management application to an accounting application, and sending a job number from the accounting application to the management application.

Certain methods may include the step of estimating the cost of completing a project. This estimating step may include entering quantities of materials into a worksheet, obtaining pricing of the materials from an electronic library, and calculating a total cost using the quantities and the pricing. In some embodiments, this may be done for labor as well as materials. In some embodiments, the library may include rental items as well as consumables. Certain embodiments may also include, where the estimate has been approved by the customer, of using the quantities of materials entered during estimating to prepare requisitions for those materials. In some embodiments, actual prices paid for the materials may be used to update the prices in the electronic library.

Further, certain methods of the present invention include a combination of some or all of the steps of creating a new project, requesting a design, estimating the cost of completing the project, preparing and presenting a project proposal, responding to change orders, responding to work orders, purchasing materials, tracking labor costs, closing out the project, invoicing, and reporting results. Certain embodiments of the invention may include steps of preparing reports that use information from the estimates and compare actual progress to predicted progress. This may include, for example, comparing actual material costs with predicted material costs, comparing actual labor cost to predicted labor cost, comparing actual completion time to predicted completion time, or a combination thereof.

Methods that include estimating may further include transferring data from estimating to purchase orders, combining purchase orders from multiple jobs to obtain more of a bulk discount, and the like. Methods that include providing agreements may include adding various clauses by clicking on items on a menu or webpage, for example. Some or all of the steps of various methods may be performed electronically, by computer, through a server, over a network, over the Internet, in real time, substantially in real time, or a combination thereof. Different embodiments of the invention, including both systems and methods, may in particular embodiments, have broad applicability, or may be limited to certain applications, such as management of construction activities, or even more specifically, to management of the construction of trade show exhibits.

Further, users of various systems in accordance with the invention may access the systems, perform method steps, or both via personal computers, laptop computers, wireless networks, telephone networks, cellular telephones, personal digital assistants, local area networks, wide area networks, the Internet, cable networks, or a combination thereof. While these exemplary embodiments are described in sufficient detail to enable those skilled in the art to practice the invention, it should be understood that other embodiments may be realized and that logical changes may be made without departing from the spirit and scope of the invention. Thus, the detailed description herein is presented for purposes of illustration only and not of limitation. For example, the steps recited in the method or process descriptions may be executed in any order and are not limited to the order presented unless indicated otherwise. In addition, various embodiments of the invention may have any combination of the modules, blocks, functions, features, and the like described herein, and do not necessarily contain all of what is described herein.

In certain particular embodiments of the invention, a number of embodiments provide a business management apparatus that includes a management server hosting a management application, an accounting server hosting an accounting application, and an intermediate server linked via a network to the management server and to the accounting server. In certain examples, the intermediate server is configured to serve as a common information depository system for the management application and the accounting application and both the accounting application and the management application are configured to transfer data to the intermediate server. Further, both the accounting application and the management application are configured to read data from the intermediate server. In this example, both the management application and the accounting application use a structured query language (SQL) database language.

In some such embodiments, the data is transferred to the intermediate server as a comma separated value (CSV) file, for example. And in some embodiments, the management application includes one or more particular software modules. For instance, the management application may include a project preliminary module configured to allow at least some of the users to input information about a potential new project and electronically transfer at least some of the information into an accounting application so that the information will not have to be reentered in the accounting application. Or, in some embodiments, the management application may include an estimating module configured to estimate a cost to complete the potential new project. In addition, in some embodiments, the management application includes a time tracker module configured to track usage of time, materials, and labor. Furthermore, in some embodiments, the management application includes a requisitioning/purchasing module configured to prepare at least one of a requisition and purchase order.

Another example of an embodiment of the invention is a computer-implemented management application configured to be loaded onto a server or a computer and to be accessed by a plurality of users through a network. This example includes a login module configured to allow authorized users to access the management application via the network and to at least partially prevent unauthorized access, a project preliminary module configured to allow at least some of the users to input information about a potential new project, and electronically transfer at least some of the information into an accounting application so that the information will not have to be reentered in the accounting application, and at least one of several other modules.

These other modules include, in this example, an estimating module configured to use at least some of the information input in the project preliminary module to estimate a cost to complete the potential new project, a time tracker module configured to use at least some of the information input in the project preliminary module to track usage of time, materials, and labor, wherein the time tracker module is configured to interface with the accounting application, and a requisitioning/purchasing module configured to use at least some of the information input in the project preliminary module to prepare at least one of a requisition and purchase order, wherein the requisitioning/purchasing module is configured to interface with the accounting application.

In some such embodiments, a job number is obtained from the accounting application after the information about a potential new project is input through the project preliminary module. And some embodiments, further include an agreement module configured to use at least some of the information input in the project preliminary module to prepare at least one agreement document for execution by a client. Further some embodiments include one particular one, any two, or all of the estimating module, the time tracker module, and the requisitioning/purchasing module. Some such embodiments further include the accounting application as part of the invention. And in some embodiments, the management application is hosted on a first server and the accounting application is hosted on a second server. In some of these embodiments, a common information depository system is hosted on a third server. In particular embodiments, at least some of the information is transferred as a comma separated value (CSV) file, the management application uses a structured query language (SQL) database language, or both.

In yet another embodiment, the invention provides a computer-implemented management system that includes a management application that includes an estimating module configured to estimate the cost and time of projects, a time tracker module configured to track actual time and actual cost of the projects, and a project performance report module configured to prepare reports that compare estimated cost and time of projects with actual time and actual cost of the projects. In this example, the management application is configured to automatically exchange information with an accounting application configured to perform accounting functions.

In some embodiments, the invention actually includes the accounting application. Further, in various embodiments, the management application further includes a project preliminary module configured to facilitate input of information about potential new projects and at least the estimating module uses at least some of the information input into the project preliminary module. And in some embodiments, the management application further includes an agreement module configured to prepare an agreement for signature for at least one of a new customer and a new project, wherein the agreement module uses at least some information generated by the estimating module. In addition, in some embodiments, the management application further includes a requisitioning/purchasing module configured to prepare at least one of requisitions and purchase orders for obtaining at least one of materials and services the requisitioning/purchasing module uses at least some information generated by the estimating module.

In a number of embodiments, the management application further includes an electronic customer library where information on a plurality of customers is stored. Furthermore, in some embodiments, the management application further includes an electronic materials library where information on a plurality of materials is stored, the information including prices of materials, and the estimating module uses at least some of the information in the materials library for estimating the cost of projects. In some embodiments, actual prices paid for materials are used to update the prices of materials in the materials library. And in some embodiments, workers are required to input time spent and materials consumed for particular projects into the time tracker module on a regular basis.

As another example, the invention also provides a network-based computer-implemented management system that includes a management application and an accounting application wherein the management application and accounting application each include SQL databases and each use DTS programming. Some embodiments are configured to automatically transfer data between the management application and the accounting application, for example.

The invention further provides a method of exchanging information in a network-based computer-implemented system. In particular examples, the method includes, in any order, at least the steps of transferring data in an comma separated value (CSV) file from a first application to an intermediate server, reading at least part of the data from the intermediate server with a second application, and populating modules in the second application with the at least part of the data. Some embodiments further include the step of performing management functions using the first application. In various embodiments the management functions including managing construction projects, or specifically, managing construction of trade show exhibits, as examples. Moreover, some embodiments, further include the step of performing accounting functions using the second application.

In another example, the invention provides a network-based, computer-implemented method of managing activities. In this example, the method includes in any order at least the steps of creating a job in a management application, entering data relevant to the job into the management application, sending at least some of the data from the management application to an accounting application, and sending a job number from the accounting application to the management application. Some embodiments further include an estimating step of estimating the cost of completing the job, and the estimating step includes using the management application and using the accounting application. In some embodiments, the estimating step includes entering quantities of materials into a worksheet, obtaining pricing of the materials from an electronic library, and calculating the cost of completing the job using at least the quantities of the materials and the pricing of the materials.

In addition, some embodiments further include the step of preparing requisitions for at least some of the materials using the quantities of materials entered in the estimating step, without the need to reenter the quantities of materials. Furthermore, some embodiments further include a step of updating the pricing of the materials in the electronic library using actual prices paid for the materials. In some embodiments, the step of preparing invoices for at least some of the materials includes using the quantities of materials entered in the estimating step, without the need to reenter the quantities of materials. In addition, in some embodiments, the estimating step includes entering quantities of labor into a worksheet, obtaining pricing of the labor from an electronic library, and calculating the cost of completing the job using at least the quantities of the labor and the pricing of the labor, as examples.

Furthermore, some embodiments include a tracking step that includes tracking labor usage, and a reporting step that includes preparing progress reports, the progress reports comparing actual labor usage determined in the tracking step to the quantities of labor entered in the estimating step, without the need to reenter the quantities of labor entered in the estimating step. Still further, in some embodiments, the estimating step includes entering quantities of rental items into a worksheet, obtaining pricing of the rental items from an electronic library, and calculating the cost of completing the job using at least the quantities of the rental items and the pricing of the rental items.

In some of these various embodiments, the job is a new construction project and the method further includes a step of requesting a design, which may include using the management application, the accounting application, or both. And in some embodiments, the job is a new construction project and the method further includes a step of responding to a change order, which includes using the management application and the accounting application. Certain embodiments include a tracking step in which the extent to which the job has been completed is tracked, and a reporting step that includes preparing progress reports which compare actual job completion determined in the tracking step to an estimated completion schedule established previously. In some embodiments, the job is a new construction project and the method further includes a step of combining purchase orders from multiple jobs to obtain a quantity discount on material purchases. And in some of these embodiments, the job may include construction of a trade show exhibit, for example.

In still another example of an embodiment, this invention provides a method of managing a plurality of construction projects. This method includes in any order the steps of using a computer-implemented accounting application to perform accounting functions associated with the construction projects, using a network-based computer-implemented management application configured to be accessed by a plurality of users and to exchange information with the accounting application so that at least some of the information will not have to be entered twice for the management application and the accounting application, and allowing at least some personnel to enter information about new projects into the management application.

This example also includes the steps of using the management application to provide guidance to the personnel to require that certain of the information be entered before proceeding to at least one subsequent step, using at least the management application, the accounting application, and the information about the new projects to estimate the cost to complete the projects, and using the estimates to produce proposals for the projects. This example of a method also includes using at least the management application, the accounting application, and the information about the new projects for preparing reports showing progress of the projects. In some embodiments, the construction projects include construction of trade show exhibits, for example.

Some information, functions, and the like may be described herein as being required, but may only be required in certain embodiments, for example, to provide structure or guidance to the process of using the invention by a particular user. Further, benefits, other advantages, and solutions to problems have been described herein with regard to specific embodiments. However, the benefits, advantages, solutions to problems, and element(s) that may cause benefit, advantage, or solution to occur or become more pronounced are not to be construed as critical, required, or essential features or elements of the claims or the invention. Reference to an element in the singular is not intended to mean “one and only one” unless explicitly so stated, but rather “one or more.” As used herein, the terms “comprises”, “comprising”, or a variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A computer-implemented system for transferring data while maintaining an acceptable level of data security, the system comprising:
an Internet server running at least a first software application;
an intranet server running at least a second software application; and
an intermediate server;
wherein the intranet server is configured to automatically initiate communication with the Internet server through the intermediate server; and
wherein the system is configured to prevent communication between the Internet server and the intranet server that is initiated by the Internet server.

2. The system of claim 1 wherein the second software application is an accounting module.

3. The system of claim 2 wherein the second software application is MICROSOFT SOLOMON.

4. The system of claim 1 wherein the first software application is a management application.

5. The system of claim 4 wherein the first software application is a management application configured to manage a plurality of construction projects.

6. The system of claim 5 wherein the first software application is a management application configured to manage the construction of a plurality of tradeshow exhibits.

7. The system of claim 1 wherein the communication includes transfer of information from the first software application to the second software application, processing of the information by the second software application into results, and transfer of the results from the second software application to the first software application.

8. The system of claim 1 wherein the communication includes transfer of a next sequential job number from the second software application to the first software application.

9. The system of claim 1 wherein the intranet server is configured to automatically initiate communication with the Internet server at particular times.

10. The system of claim 1 wherein the intranet server is configured to automatically initiate communication with the Internet server at periodic intervals of time.

11. The system of claim 1 wherein the intranet server is running on MICROSOFT WINDOWS having a Scheduled Task option, and the Scheduled Task option is used to automatically initiate communication with the Internet server.

12. The system of claim 1 wherein the first software application includes a project preliminary module.

13. The system of claim 1 wherein the first software application includes a new client request module.

14. The system of claim 1 wherein the first software application includes a vendor editor module.

15. The system of claim 1 wherein the first software application includes a requisition/purchasing module.

16. The system of claim 1 wherein the first software application includes a time tracker module.

17. The system of claim 1 wherein the first software application includes a project performance module.

18. A method for transferring data between an Internet server and an intranet server while maintaining an acceptable level of data security, the method comprising in any order at least the steps of:
using the intranet server to initiate communication between the intranet server and the Internet server through an intermediate server; and
not allowing communication between the Internet server and the intranet server that is initiated by the Internet server.

19. The method of claim 18 further comprising the steps of:
transferring information from the Internet server to the intranet server through the intermediate server;
processing the information into results at the intranet server; and
transferring the results from the intranet server to the Internet server.

20. The method of claim 19 wherein the processing comprises performing computations using an accounting application.

21. The method of claim 20 wherein the processing comprises performing computations using MICROSOFT SOLOMON.

22. The method of claim 18 further comprising the step of managing a plurality of construction projects using a management application loaded on the Internet server.

23. The method of claim 22 wherein the managing a plurality of construction projects comprises managing the construction of a plurality of trade show exhibits.

24. The method of claim 18 further comprising the step of transferring a next sequential job number from the intranet server to the Internet server.

25. The method of claim 18 wherein the step of using the intranet server to initiate communication includes automatically initiating communication at particular times.

26. The method of claim 18 wherein MICROSOFT WINDOWS having a Scheduled Task option is loaded on the intranet server and the method further includes the step of using the Scheduled Task option to automatically initiate communication with the Internet server.

27. A computer-implemented management system comprising a plurality of software modules including:
an estimating module configured to be used to estimate the time and cost of projects; and
a plurality of other modules configured to perform specific functions;
wherein the other modules are each configured to interface predominantly with the estimating module such that the estimating module serves as a hub for the other modules within the management system.

28. The management system of claim 27 wherein data entered initially into the estimating module is used to populate fields in at least a plurality of the other modules.

29. The management system of claim 28 wherein data entered initially into the estimating module is used to populate fields in all of the other modules.

30. The management system of claim 27 further comprising an accounting application configured to perform accounting functions.

31. The management system of claim 27 further comprising a first server onto which the estimating module is loaded and a second server onto which the accounting application is loaded.

32. The management system of claim 31 further comprising an intermediate server configured and arranged to facilitate transfer of information between the first server and the second server.

33. The management system of claim 31 wherein the first server is an Internet server and the second server is an intranet server.

34. The management system of claim 27 wherein the other modules include a time tracker module configured to track actual time and actual cost of the projects.

35. The management system of claim 27 wherein the other modules include a project performance report module configured to prepare reports that compare estimated cost and time of projects with actual time and cost of the projects.

36. The management system of claim 27 further comprising a project preliminary module configured to facilitate input of information about potential new projects and wherein at least the estimating module uses at least some of the information input into the project preliminary module.

37. The management system of claim 27 wherein the other modules include an agreement module configured to prepare an agreement for signature for at least one of a new customer and a new project.

38. The management system of claim 27 wherein the other modules include a requisitioning/purchasing module configured to prepare at least one of requisitions and purchase orders for obtaining at least one of materials and services.

39. A method of managing a plurality of construction projects, the method comprising in any order the steps of:
using a computer-implemented accounting application loaded on an intranet server to perform accounting functions associated with the construction projects;
using a network-based computer-implemented management application loaded on an Internet server and configured to be accessed by a plurality of users and to exchange information with the accounting application so that at least some of the information will not have to be entered twice for the management application and the accounting application;
allowing at least some personnel to enter information about new projects into the management application;
using the management application to provide guidance to the personnel to require that certain of the information be entered before proceeding to at least one subsequent step;
using at least the management application, the accounting application, and the information about the new projects, estimating the cost to complete the projects and using the estimating to produce proposals for the projects; and
using at least the management application, the accounting application, and the information about the new projects, preparing reports showing progress of the projects.

40. The method of claim 39 wherein the construction projects include construction of trade show exhibits.

41. The method of claim 39 wherein communication between the management application and the accounting application occurs only when initiated by the accounting application.

42. The method of claim 39 further comprising the step of using an intermediate server to facilitate communication between the management application and the accounting application.
